(19) United States
(12) Patent Application Publication
(10) Pub. No.: US 2026/0186523 A1
(43) Pub. Date: Jul. 2, 2026

(54) PROGRAMMABLE MEMORY ASSIST

(71) Applicant: MICROSOFT TECHNOLOGY LICENSING, LLC, Redmond, WA (US)

(72) Inventors: Serena BADRAN-LOUCA, Raleigh, NC (US); Suraj BALASUBRAMANIAN, Morrisville, NC (US); Richard Gerard HOFMANN, Cary, NC (US); Jeremiah FRANKE, Tigard, OR (US)

(21) Appl. No.: 19/007,388

(22) Filed: Dec. 31, 2024

(51) Int. Cl. G06F 1/08; G06F 1/3206

(52) U.S. Cl. CPC G06F 1/08; G06F 1/3206

(57) ABSTRACT

The disclosed techniques provide a dynamic voltage and frequency scaling (DVFS) module and a domain residing in a core. The DVFS module includes a Voltage and Memory Assist Table (VMAT), including firmware-programmable registers that store target voltages that correspond to performance states and firmware-programmable registers that store memory assist values that correspond to the performance states. The domain includes memories. The DVFS module is configured to, during a current performance state: provide a core voltage to the domain, such that the core voltage is provided based on a target voltage among the target voltages that corresponds to the current performance state, and provide memory assist signaling to the memories, such that the memory assist signaling is provided based on the memory assist values that correspond to the current performance state. The DVFS module uses an efficient crawl to transition memory assist values from one performance state to another performance state.

### BACKGROUND

A system-on-a-chip (SoC) may use Dynamic Voltage and Frequency Scaling (DVFS) to optimize power dissipation at desired performance levels. The SoC has multiple performance states (Pstates), and each Pstate has a target voltage and a clock frequency. The SoC determines the appropriate Pstate for a core of the SoC by evaluating the current workload, environmental conditions, and required performance. During a change to a new Pstate, the SoC looks up the target voltage and clock frequency for the new Pstate in one or more hardcoded look-up tables. Components on the SoC provide a clock signal to the core at that determined clock frequency. Components on the SoC also provide a core voltage to the core at that determined target voltage. For example, if a task is computationally intensive, the SoC selects a Pstate with an increased target voltage and clock frequency to match the requirements. If the task is less computationally intensive, the SoC adjusts the target voltage and clock frequency accordingly. However, although DVFS allows a system to adjust the core voltage to save power, there is an increased risk of data errors when the core's memories operate at lower voltages.

To mitigate this risk, the SoC may use memory assistance, which includes the adjustment of memory parameters to decrease the likelihood of data errors, especially at low voltages. In one example, an SoC adjusts the memory parameters by providing memory assist values to memory components in the core. The memory assist values include memory assist bits that indicate the specific memory assistance that is to be performed by the memory components. The memory components then receive the memory assist values and adjust to the corresponding memory assistance level. One example of memory assistance is extending the pulse width of memory accesses. Other examples include adjusting memory parameters such as output driver strength, enable signals, and pre-charge duration.

The memory assist bits indicate the extent of the memory assistance to be performed. As the core voltage decreases, more memory assistance becomes necessary to avoid data errors. At the lowest possible core voltage, in some examples, the memory assist bits are provided so that all forms of memory assistance are activated to the maximum extent. Conversely, at the highest possible core voltage, in some examples, the memory assist bits are provided so that all memory assistance are off. Some of the memory assist bits are written into control status registers and do not change based on the core voltage. Other memory assist bits change based on the core voltage. When the core voltage changes, a finite state machine (FSM) that detects whether the core voltage is going up or down is used to change the memory assist bits in sequence with the core voltage change. Then, those memory assist values are provided to one or more memory components.

Existing techniques that utilize hardcoded memory assist values provide some performance benefits, however, this design has some drawbacks. For example, since SoC designers need to determine precise memory assist values needed for each Pstate through extensive simulation and testing, the memory assist values may need to be changed during the design execution cycle of the SoC. In such scenarios, a memory vendor may provide memory assist values in a memory datasheet. Design engineers then hardcode the memory assist values from the memory datasheet into the logic of the FSM during the design execution cycle. The memory vendor often changes the memory datasheet throughout the design execution cycle. When the memory datasheet changes, the design engineers must perform a redesign of a part of the SoC to accommodate the changes. This can lead to prolonged production cycles that require a costly process each time that memory assist value adjustments are required.

### SUMMARY

To address the above-described issues, the disclosed techniques provide a system with programmable registers used for storing memory assist values and target voltage levels that correspond to Pstates of a core of an SoC. In some embodiments, a system includes the use of firmware-programmable registers in a Voltage and Memory Assist Table (VMAT) to store the memory assist values. When a change to the memory assist values stored in the VMAT is required, the SoC programs the updated memory assist values into the firmware-programmable registers using machine instructions. Then, during operation of the SoC, the SoC retrieves the memory assist values from the firmware-programmable registers rather than utilizing memory assist values hardcoded in an FSM. By introducing firmware-programmable registers to store memory assist values of a VMAT, a design process does not require repeated redesign of the SoC to change memory assist values that correspond to various Pstates.

In some embodiments, an SoC uses a VMAT crawl mode to enhance the performance of a Pstate transition from a starting Pstate to a target Pstate. When in the VMAT crawl mode, the SoC causes a pointer index to traverse (“crawl”) through the Pstates that each correspond to a memory assist value in the VMAT. As the pointer index incrementally crawls through individual Pstates from a starting Pstate to a target Pstate, the SoC selectively changes the memory assist values provided to the memory components in the core when the SoC detects a change in the memory assist value. For example, when the pointer index crawls from a first Pstate having a first memory assist value to a second Pstate with a different memory assist value, the SoC retrieves the memory assist values that corresponds to the second Pstate. The SoC then provides the memory assist value in the VMAT that corresponds to the second Pstate to the memory components in the core. When the pointer index crawls from the second Pstate to a third Pstate with the same memory assist value as the second Pstate, the SoC maintains the memory assist values provided to the memory components in the core, without the need to retrieve the memory assist values that corresponds to the third Pstate.

In some embodiments, the system also utilizes an early exit procedure during the VMAT crawl process. Once the pointer index reaches a Pstate that has the same memory assist values as the target Pstate, the SoC makes an early exit from the VMAT crawl mode. By making an early exit from the VMAT crawl mode, the desired Pstate and corresponding memory assist values can be achieved without requiring the pointer to traverse through each interim Pstate.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A shows a block diagram of an embodiment of a system that uses a programmable memory assist in which the memory assist values are changed by firmware.

FIG. 1B shows a block diagram of an embodiment of the system of FIG. 1A in which the changed memory assist values are used in memory assist signaling.

FIG. 1C shows a block diagram of an embodiment of a System on a Chip (SoC) with multiple cores that each use a programmable memory assist configuration.

FIG. 2A shows a block diagram of a first state of an embodiment of an example SoC that uses a programmable memory assist configuration and a Voltage and Memory Assist Table (VMAT) crawl mode, illustrating an example of a performance state change from Performance Number (Pn) 0 to 6.

FIG. 2B shows a second state of an embodiment of the SoC of FIG. 2A.

FIG. 2C shows a third state of an embodiment of the SoC of FIG. 2A.

FIG. 2D shows a fourth state of an embodiment of the SoC of FIG. 2A.

FIG. 2E shows a fifth state of an embodiment of the SoC of FIG. 2A.

FIG. 2F shows a sixth state of an embodiment of the SoC of FIG. 2A.

FIG. 3A shows a block diagram of a first state of an embodiment of an SoC that uses a programmable memory assist configuration and a VMAT crawl mode, illustrating an example of a performance state change from Pn 4 to Pn 0.

FIG. 3B shows a second state of an embodiment of the SoC of FIG. 3A.

FIG. 3C shows a third state of an embodiment of the embodiment of the SoC of FIG. 3A.

FIG. 3D shows a fourth state of the SoC of FIG. 3A.

FIG. 4A shows a block diagram of a first state of an embodiment of an SoC that uses a programmable memory assist configuration and a VMAT crawl mode, illustrating an example of a performance state change from Pn 0 to 6, with different memory assist values than the example illustrated in FIGS. 2A-2F.

FIG. 4B shows a second state of an embodiment of the SoC of FIG. 4A.

FIG. 4C shows a third state of an embodiment of the SoC of FIG. 4A.

FIG. 4D shows a fourth state of an embodiment of the SoC of FIG. 4A.

FIG. 4E shows a fifth state of an embodiment of the SoC of FIG. 4A.

FIG. 5A shows a block diagram of an embodiment of a system that uses a programmable memory assist configuration.

FIG. 5B shows a block diagram of an embodiment of the system of FIG. 5A in which the Dynamic Voltage and Frequency Scaling (DVFS) module is in the core.

FIG. 6 shows a flowchart of an embodiment of a process for using a programmable memory assist configuration.

FIG. 7 shows a flowchart of an embodiment of a process for a VMAT crawl mode.

FIG. 8 shows a block diagram of a computing-based device that may be included in an example of any of the above systems.

### DETAILED DESCRIPTION

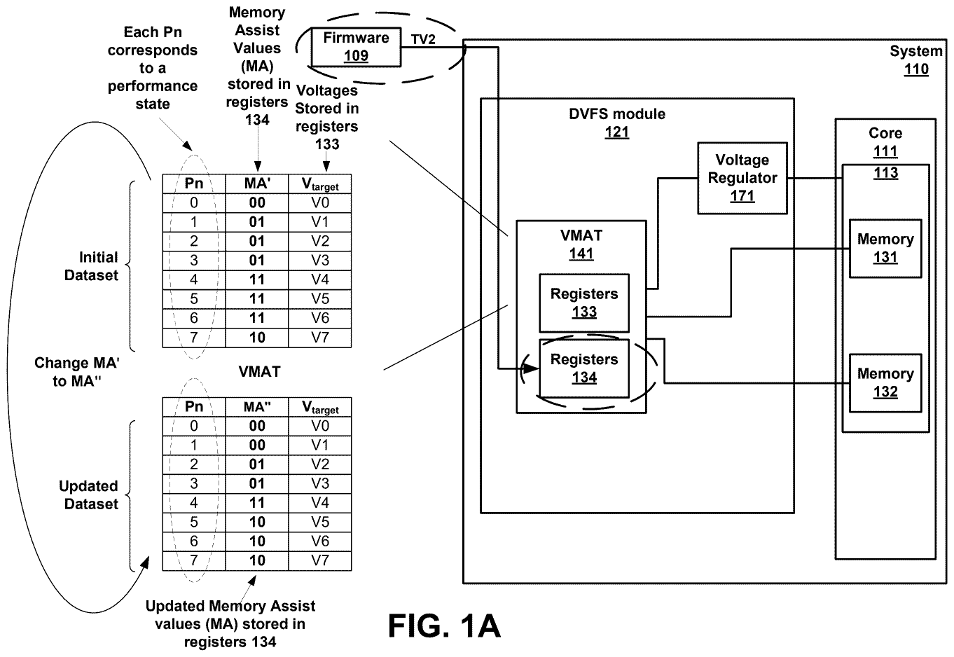

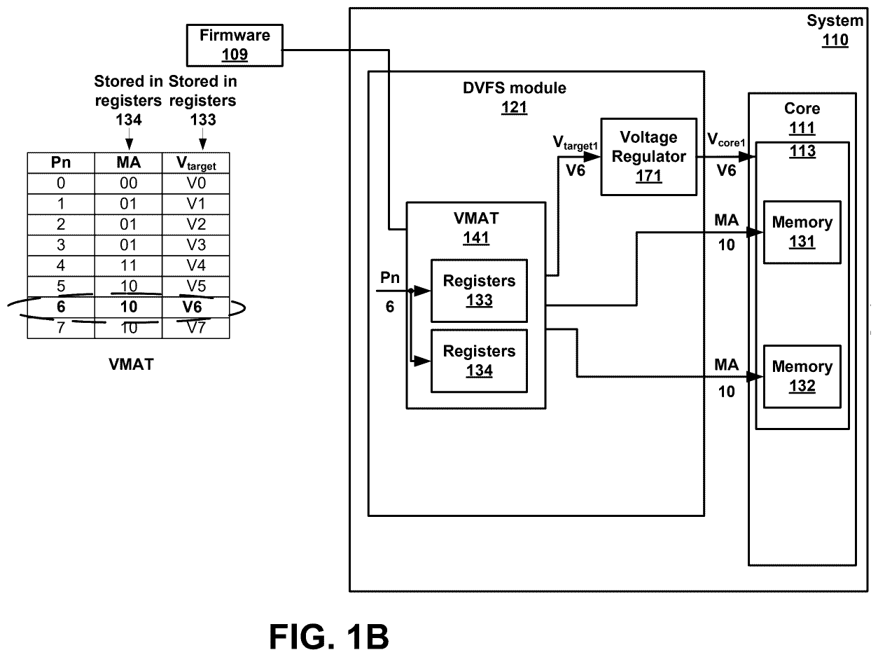

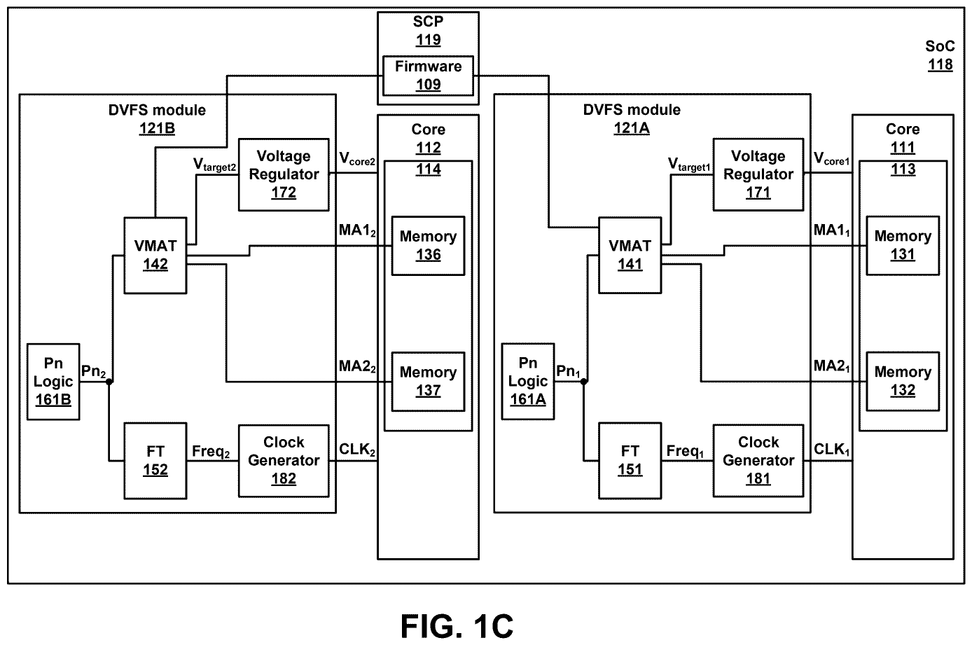

FIG. 1A shows a block diagram of a system 110 that uses programmable registers for storing memory assist values that correspond to performance states (“Pstates”) of a core of the system. The system 110 includes a core 111 and a Dynamic Voltage and Frequency Scaling (DVFS) module 121. The DVFS module 121 includes a voltage regulator 171 and a Voltage and Memory Assist Table (VMAT) 141. The VMAT 141 includes a first set of registers 133 and a second set of registers 134, both of which are configured to be programmable. The first set of registers 133 is used to store individual voltage values that correspond to a particular performance state. The second set of registers 134 is used to store individual memory assist values that each correspond to a particular performance state. The voltage regulator 171 provides a supply voltage to the core 111 based on target voltage values that correspond to a desired performance state. The VMAT also provides the individual memory assist values that correspond to the desired performance state.

The core 111 includes a domain 113. A domain refers to a region of a core with components that share a supply voltage and a clock signal. A domain within a core can include a number of memory components. A memory assist value that is communicated to that domain is also communicated to all of the memory components within that domain, and each memory component in the domain concurrently uses the communicated memory assist value. Also, a core voltage that is communicated to a domain is communicated to all of the components in that domain, and each component in the domain concurrently uses the core voltage as its supply voltage. The domain 113 is a portion of the system 110 that operates on its own clock signal and supply voltage. The domain 113 includes memory modules, such as a first memory 131 and a second memory 132. The system 110 is also in communication with firmware 109 that is configured to modify the memory assist values. In some embodiments, the firmware 109 is part of the system 110, and in other embodiments, the firmware 109 is external to the system 110. In some embodiments, the DVFS module 121 is external to the core 111, and in other embodiments, the DVFS module 121 is part of the core 111.

FIGS. 1A and 1B show the system in two operational states. FIG. 1A shows a state of the system 110 during a design execution cycle, in which the firmware 109 is used to program a set of registers. The design execution cycle is the process of developing and implementing a chip design, from initial conception through simulation, layout, and fabrication. FIG. 1B shows another state of the system 110 in normal operating mode using the programmed registers, after the design execution cycle.

With reference to FIG. 1A, a programming process for a set of registers is shown and described below. This process may be performed during the design execution cycle. For illustrative purposes, this example includes a given dataset in the first table (top table), which is also referred to herein as an initial dataset. By the programming process described below, this initial dataset is modified by the firmware 109 to generate an updated dataset, which is shown in the second table (bottom table). The initial dataset includes a first set of memory values MA′, e.g., initial memory assist values. The updated dataset includes a second set of memory assist values MA″, e.g., updated memory assist values. The memory assist values include memory assist bits that indicate the specific memory assistance that is to be performed by memory components (e.g., the first memory 131 and the second memory 132) in the domain 113.

The VMAT 141 stores target voltages in a first set of registers 133, and memory assist values are stored in a second set of registers 134. Each performance state has a corresponding performance number (Pn) which identifies individual performance states. For instance, the corresponding memory assist values for the performance state with a Pn of 0 are 00, and the corresponding memory assist values for the performance state with a Pn of 1 are 01, etc. In some configurations, the memory assist bits use Gray encoding, as discussed in greater detail below. Similarly, a target voltage can be determined for each performance state. In this example, for the performance state with a Pn of 0, the corresponding target voltage is V0, for the performance state with a Pn of 1, the corresponding target voltage is V1, etc.

The embodiment of FIG. 1A shows a process where the firmware 109 modifies the memory assist values stored in the second set of registers 134. In this embodiment, the firmware changes the memory assist values from a first set of values MA′ to a second set of values MA″. Specifically, the memory assist values for the performance state with a Pn of 1 changed from 01 to 00, the performance state with a Pn of 5 changed from 11 to 10, etc. By using firmware 109 to program or change the memory assist values stored in the second set of registers 134, the design process does not require a redesign of system 110 to change the memory assist values.

In some embodiments, in addition to the first set of registers 133 and the second set of registers 134, the VMAT 141 also includes other registers and other storage components, some of which store hardware-constant values, and some of which store firmware-programmable values. For example, in some embodiments, the VMAT 141 also includes registers that store memory assist bits that do not change based on the core voltage.

Although FIG. 1A and some other figures show eight performance states, it can be appreciated that the disclosed techniques can be applied to a system with any suitable number of performance states. Similarly, although FIG. 1A and some other figures show two memory assist bits being used, it can be appreciated that the disclosed techniques can be applied to any number of memory assist bits, e.g., one memory assist bit, three memory assist bits, etc.

FIG. 1B is a block diagram of the system 110 in a normal operating mode, which occurs after the design execution cycle is complete. In normal operating mode, the system 110 determines the appropriate performance state for the domain 113 of the core 111 by evaluating one or more factors including, but not limited to, a current workload, environmental conditions, and required performance. The system 110 then uses the determined performance state to determine corresponding memory assist values MA and a core voltage V_{core1} for the domain 113. The system then supplies the memory assist values MA to the memories (131, 132) and causes the voltage regulator 171 to supply the determined core voltage V_{core1} to the domain 113.

In one illustrative example, consider a scenario where the system 110 selected a particular performance state, e.g., a Pstate with a Pn of 6 based on given workload. Once the performance state is selected, the system obtains the corresponding target voltage using the VMAT. Based on the Pstate with a Pn of 6, the system reads the target voltage V6 from the VMAT. After looking up the target voltage for Pn of 6, the VMAT 141 provides the target voltage V_{target1} to the voltage regulator 171. In response to receiving the target voltage V_{target1}, the voltage regulator 171 provides the core voltage V_{core1} at a voltage level of V6 to the domain 113. The core voltage V_{core1} is a supply voltage for the domain 113 of the core 111.

In continuing the above-described example, DVFS module 121 also looks up the memory assist values for a Pn of 6 in the VMAT 141. As shown in FIG. 1B, the memory assist values for the performance state with a Pn of 6 is 10. The VMAT 141 then provides memory assist values 10 to the memory components in the domain 111. For instance, in some embodiments, the VMAT 141 provides memory assist values 10 to both the first memory 131 and the second memory 132. In response to receiving memory assist values 10, the first memory 131 and the second memory 132 each perform the specific memory assistance that is indicated by memory assist values 10. The VMAT 141 continues to provide the memory assist values 10 to the first memory 131 and the second memory 132 until the performance state changes from Pn 6 to a different performance state.

The order in which the core voltage and the memory assist values are adjusted depends on whether the core voltage is increasing or decreasing. When the core voltage is increased, the core voltage is increased before the memory assist bits are changed. When the core voltage is decreased, the memory assist bits are changed before the core voltage is decreased.

Although FIG. 1A and FIG. 1B each show a configuration of the system 110 with one core, it can be appreciated that the disclosed techniques can be applied to a system with more than one core. FIG. 1C illustrates one configuration in which the system 110 is an SoC with more than one core.

FIG. 1C shows a block diagram of an embodiment of an SoC 118 that uses programmable registers for storing memory assist values that correspond to performance states of the cores of the SoC. The SoC 118 may be used as an embodiment of the system 110 of FIG. 1A and FIG. 1B. The SoC 118 includes a first core 111, a second core 112, a first DVFS module 121A, a second DVFS module 121B, and a System Control Processor (SCP) 119. The first DVFS module 121A and the second DVFS module 121B are collectively referred to herein as DVFS modules 121. The SCP 119 includes firmware 109. The first core 111 includes a first domain 113 that includes a first memory 131 and a second memory 132. Likewise, the second core 112 includes a second domain 114 that includes a third memory 136 and a fourth memory 137. The first DVFS module 121A includes a first Performance Number (Pn) logic module 161A, a first VMAT 141, a first Frequency Table (FT) 151, a first voltage regulator 171, and a first clock generator 181. Likewise, the second DVFS module 121B includes a second Pn logic module 161B, a second VMAT 142, a second FT 152, a second voltage regulator 172, and a second clock generator 182.

The SoC 118 may be used in numerous applications, such as embedded systems applications in which it is desirable to have low power consumption without sacrificing performance. The SoC 118 may also be used in numerous other suitable applications, such as vast cloud systems. The SoC 118 is a multi-core SoC that employs DVFS and memory assist signaling using programmable memory assist values. As discussed above, the use of a programable memory assist configuration allows the SoC 118 to be designed in such a way that the design process is not hindered by changes in the memory datasheets for the memory assist values used in the memory assist signaling. In some configurations, as discussed in greater detail below, not only does the SoC 118 use programmable registers to store memory assist values, e.g., the SoC uses a programmable memory assist configuration, but the SoC 118 can also use a VMAT crawl mode that reduces the time required to change performance states and does so in a way that avoids metastability and timing failures.

For each core, there is a DVFS module that performs DVFS and memory assist signaling for that core. For example, the first DVFS module 121A is arranged to perform DVFS functionality and memory assist signaling for the first core 111. Likewise, the second DVFS module 121B is arranged to perform the DVFS functionality and memory assist signaling for the second core 112. The SCP 119 is arranged to perform various system management functions for the SoC 118.

The System Control Processor (SCP) 119 may be implemented using a number of different configurations. For instance, in some configurations, the SCP 119 is a separate, dedicated core that handles system management functions independently of the main cores (e.g., the cores 111 and 112). Although the SCP 119 is shown as a separate component in FIG. 1C, in other configurations, the SCP 119 is integrated into one of the main cores (e.g., the cores 111 and 112). In yet another configuration, the SCP 119 is embedded in an on-chip peripheral as a power management resource. The firmware 109 of the SCP 119 may provide various functionality, such as power management, thermal monitoring, error handling, scheduling, resource arbitration, inter-core communication, task debug and trace facilities, system security, controlling specialized hardware accelerators or coprocessors that augment the main cores, or handling aspects of the operating system (OS) boot and initialization before handing off the operating system to the main cores (e.g., the cores 111 and 112).

The memory components (also referred to herein as “memories” 131, 132, 136, 137) in the cores (e.g., cores 111 and 112) may be, for example, Random Access Memories (RAMs) or other suitable types of memories. The memories (e.g., 131, 132, 136, 137) in the cores (e.g., the cores 111 and 112) may be used for multiple purposes, including temporarily storing data and code that runs on the SoC 118.

The DVFS modules 121 control the core voltage, clock frequency, and memory assist signaling for their respective cores according to a selected performance state for each core. For illustrative purposes, the term “memory assist signaling” means providing signals, e.g., memory assist values, to one or more memories, where the signals indicate a specific memory assistance that is to be performed by the memories. In some embodiments, performance states are distinct voltage-frequency combinations that are configured for a domain in a core. The SoC 118 evaluates various factors, including SoC power dissipation, and dynamically adjusts the performance state for each core accordingly. The DVFS modules 121 can then provide different memory assist signaling to memory of each core using performance states that are determined for each core.

In some configurations, for each particular performance state at which each core operates, the system stores individual parameters, such as the target voltage, target frequency, and memory assist values. For example, for each performance state, there is a defined target voltage for that performance state. In this way, for each performance state at which a core operates, an individual VMAT (e.g., VMAT 141 or 142) can be used to look up and apply the target voltage that is defined for that performance state. Similarly, because there is a target frequency and memory assist values defined for each performance state, an individual VMAT can be used to look up and apply the target frequency and memory assist values that are defined for that performance state.

The Performance Number (Pn) logic modules 161 are used to determine performance states for each core of the SoC 118. This includes determining when a performance state change should occur, and, upon determining that a performance state change should occur, the Pn logic modules 161 also determines what the new performance state should be. In at least some embodiments, when a performance state change occurs, a Pn logic module 161 uses information received from an operating system (OS) or the SCP 119 to perform Pn arbitration logic to determine an arbitration winner among performance states. The determined arbitration winner is used as the new performance state. When a performance state change is complete, the Pn logic modules 161 determine a performance state to be used for each core, until another performance state change occurs. In this embodiment, the first Pn logic module 161A determines a first performance state having a first performance number, Pn₁, for the first core 111, and the second Pn logic module 161B determines a second performance state having a second performance number, Pn₂, for the second core 112.

The Frequency Table (FT) is a look-up table that stores the target clock frequency for each performance state at which each core is to operate. For example, during a performance state change for the first core 111, the first DVFS module 121A accesses the first FT 151 to look up a first target clock frequency (Freq₁) for Pn₁, the performance number of the new performance state. The first FT 151 then provides the determined first target clock frequency Freq₁ to the first clock generator 181. In response, the first clock generator 181 provides a first clock signal CLK₁ such that the first clock signal CLK₁ is at the determined first target clock frequency Freq₁. The first core 111 then receives the first clock signal CLK₁. The second DVFS module 121B can perform a similar process to provide a clock signal CLK₂ that is at the second target clock frequency Freq₂ for the second core 112.

After each performance state change, the first clock generator 181 continuously provides the first clock signal CLK₁ at the determined first target clock frequency Freq₁ to the first core 111 until another performance state change occurs. In some embodiments, the first clock generator 181 includes at least one phase-locked loop (PLL) and supporting hardware elements. The supporting hardware elements may include, for example, one or more registers, state machines, control logic, interface elements, or the like. The second clock generator 182 functions in a similar manner by continuously providing the second target clock signal CLK₂ at a determined second clock frequency Freq₂ until another performance state change occurs.

Although the FT 151 and the VMAT 141 both operate based on performance states, the FT 151 and the VMAT 141 operate independently of each other. The operations of the FT 151 are parallel with the operations of the VMAT 141, but not conjoined with the operations of the VMAT 141. Similarly, although the FT 152 and the VMAT 142 both operate based on Pstates, the FT 152 and the VMAT 142 operate independently of each other. The operations of the FT 152 are parallel with the operations of the VMAT 142, but not conjoined with the operations of the VMAT 142.

The first VMAT 141 is a look-up table that includes firmware-programmable registers that store programmable parameters, including target core voltage values and memory assist values for each performance state at which the first core 111 is configured to operate. The programmable parameters are subject to changes during the design execution cycle of the SoC 118. For example, the memory assist values may need to be changed due to an updated memory datasheet. When the programmable parameters need to be changed, the firmware 109 programs the firmware-programmable registers in the first VMAT 141 to change the values. In this way, the memory assist values can be changed without performing a redesign on the SoC 118. In some embodiments, the firmware 109 is used to change the memory assist values during the design execution cycle. In some embodiments, the firmware 109 can change the memory assist values at boot time. The second VMAT 142 functions in a similar manner as described above with respect to the first VMAT 141.

During a performance state change, the first DVFS module 121A looks up, in the first VMAT 141, the first target voltage V_{target1} and the memory assist values (e.g., MA1₁ and MA2₁) for Pn₁. The first DVFS module 121A also provides the first target voltage V_{target1} to the first voltage regulator 171. The first DVFS module 121A also provides the memory assist values (e.g., MA1₁ and MA2₁) to the memories (e.g., the first memory 131 and the first memory 132) in the first core 111. For instance, in some embodiments, the first VMAT 141 is configured to provide memory assist values MA1ᵢ to the first memory 131, and further configured to provide memory assist values MA2₁ to the second memory 132. The second DVFS module 121B performs the same functions independently to provide a second target voltage V_{target2} to the second voltage regulator 172 and memory assist values MA1₂ and MA2₂ to the memories in the second core 112.

In some configurations, each voltage regulator includes a power analog macro that includes at least one low-dropout (LDO) regulator and supporting hardware elements. The supporting hardware elements may include, for example, a digital-to-analog converter, interface elements, reference buffers, filters, power transistors, coupler modules, op amps, multiplexers, or the like.

The first voltage regulator 171 is arranged to receive the first target voltage V_{target1}. In some configurations, the first target voltage V_{target1} is a digital signal that indicates a target voltage. The first voltage regulator 171 is arranged to provide an analog voltage, V_{core1}, at the voltage level indicated by V_{target1}. The first core 111 is arranged to receive the first core voltage V_{core1}. The first core voltage V_{core1} is not necessarily the supply voltage for the entire first core 111, although it is in some configurations. Rather, in at least some configurations, the first core voltage V_{core1} is the supply voltage of a domain in the first core 111 that controls the memories (e.g., 131 and 132) in the first core 111. After a performance state change is completed, the first voltage regulator 171 continues to provide the first core voltage V_{core1} at the voltage level indicated by V_{target1} until another performance state change occurs. The second voltage regulator 172 independently performs the above-described process for the second core 112.

The DVFS modules 121 operate on different clock domains than the memories. That is, the memories operate on a clock frequency that is asynchronous with the DVFS modules. When data is communicated between different clock domains, the data is “crossing a clock boundary.” When data crosses a clock boundary, there is a risk of a timing failure, such as metastability. Metastability is the phenomenon where a bit becomes stuck in an indeterminate state between logic “0” and “1.” Metastability can occur when a flip-flop violates setup or hold requirements. Additionally, other timing failures can occur when data is communicated between different clock domains. Because the memory assist values cross a clock boundary when communicated from the DVFS modules 121 to the memories, there is a risk of metastability and timing failures in the memories.

In order to avoid timing failures, Gray encoding is used for memory assist values communicated from DVFS modules 121 to the memories. Gray encoding is an ordering of values such that any two successive values differ in only one bit. For instance, one example of Gray code is as follows:

TABLE 1
Gray Code Example

| Decimal | Binary | Gray |
|---|---|---|
| 0 | 000 | 000 |
| 1 | 001 | 001 |
| 2 | 010 | 011 |
| 3 | 011 | 010 |
| 4 | 100 | 110 |
| 5 | 101 | 111 |
| 6 | 110 | 101 |
| 7 | 111 | 100 |

For example, in standard binary code, decimal 3 is encoded as 011, and decimal 4 is encoded as 100. This means that when a corresponding decimal value transitions from 3 to 4, the standard binary code transitions from 011 to 100. When the binary code transitions from 011 to 100, three bits change. However, in the Gray code example shown above, when a corresponding decimal value transitions from 3 to 4, the example Gray code transitions from 010 to 110. When the Gray code transitions from 010 to 110, only one bit changes. The Gray code/coding creates a single-bit transition across asynchronous clock boundaries. By using Gray coding to communicate memory assist values when crossing the clock boundary from the DVFS module to the memories, isolation of an asynchronous path for timing purposes is achieved, which accordingly avoids metastability and timing failures with the crossing of the clock boundary.

When one of the memories receives memory assist values, the memory performs the memory assistance indicated by the memory assist values. For instance, in an embodiment that uses Gray encoding and three memory assist bits, 000 may be used to indicate no memory assistance, and 100 may be used to indicate that all memory assistance is to be used to the maximum extent. In this embodiment, the other six values that are in between 000 and 100 indicate intermediate levels of memory assistance that are in between no memory assistance and the maximum extent of memory assistance.

Various embodiments of the SoC 118 may have more or less components than illustrated in FIG. 1C and may have different suitable arrangements than the specific arrangement illustrated in FIG. 1C. For example, although FIG. 1C illustrates two cores, in various embodiments, the SoC 118 may have any suitable number of cores, e.g., one core, three cores, etc., with a corresponding DVFS module for each core. Also, although the embodiment of the SoC 118 illustrated in FIG. 1C shows each of the DVFS modules as being external to the corresponding cores, in some embodiments, each DVFS module is part of its corresponding core, rather than being external to its corresponding core.

In some configurations, the SoC 118 uses a VMAT crawl mode to enhance the speed of a performance state change from a starting performance state to a target performance state. During a performance state change from a lower performance to a higher performance, e.g., an upward direction in performance change, for the first core 111 that uses a VMAT crawl mode, the performance state change proceeds as follows. First, the Pn logic module 161A selects the first target performance number Pn₁, which is the target performance state index. Next, the first VMAT 141 sends the first target voltage V_{target1} for the target performance state to the first voltage regulator 171. In response, the first voltage regulator 171 provides the first core voltage V_{core1}, thus raising the voltage. Next, the first VMAT 141 waits for the first core voltage V_{core1} to reach its target and then performs the VMAT crawl mode and provides the first memory assist values MA1₁ to the first memory 131 and the second memory assist values MA2₁ to the second memory 132. The VMAT crawl mode is discussed in greater detail below. After the VMAT crawl mode is completed, the first FT 151 sends the first target clock frequency Freq₁ for the target performance state to the first clock generator 181. In response, the first clock generator 181 provides the first clock signal CLK₁ at the first target clock frequency Freq₁, thereby raising the clock frequency. The second DVFS module 121B operates in a similar manner with regard to a performance state change from a lower performance to a higher performance for the second core 112 that uses a VMAT crawl mode.

During a performance state change from a higher performance to a lower performance, e.g., a downward direction in performance change, for the first core 111 that uses a VMAT crawl mode, the performance state change proceeds as follows. First, the Pn logic module 161A selects the first target performance number Pn₁, which is the target performance state index. Next, the first FT 151 sends the first target clock frequency Freq₁ for the target performance state to the first clock generator 181. In response, the first clock generator 181 provides the first clock signal CLK₁ at the first target clock frequency Freq₁, thereby lowering the clock frequency. Next, the first VMAT 141 waits for the first clock signal CLK₁ to reach its target and then performs the VMAT crawl mode and provides the first memory assist values MA1₁ to the first memory 131 and the second memory assist values MA2₁ to the second memory 132. The VMAT crawl mode is discussed in greater detail below. After the VMAT crawl mode is completed, the first VMAT 141 sends the first target voltage V_{target1} for the target performance state to the first voltage regulator 171. In response, the first voltage regulator 171 provides the first core voltage V_{core1}, thereby lowering the voltage. The second DVFS module 121B operates in a similar manner with regard to a performance state change from a higher performance to a lower performance for the second core 112 that uses a VMAT crawl mode.

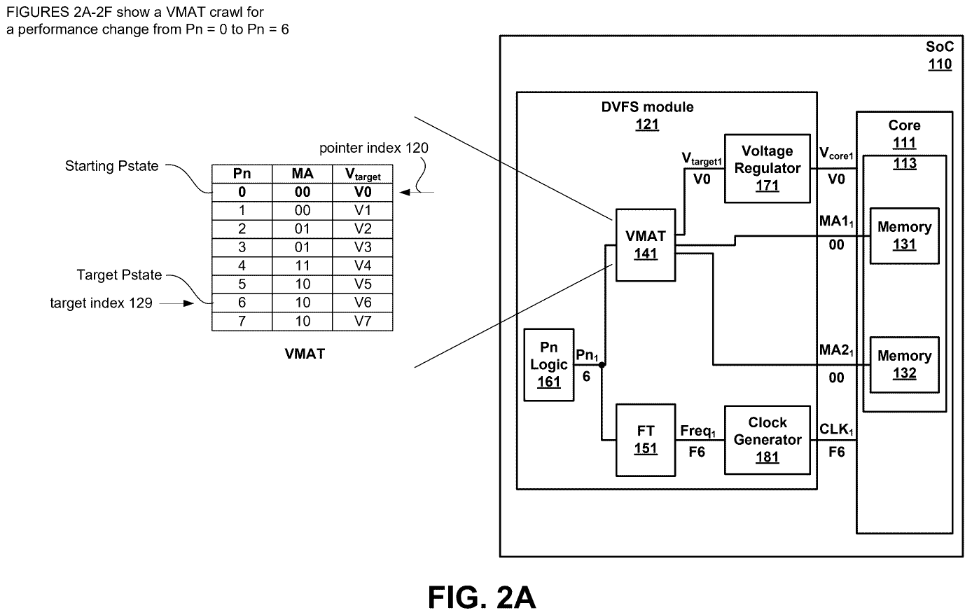

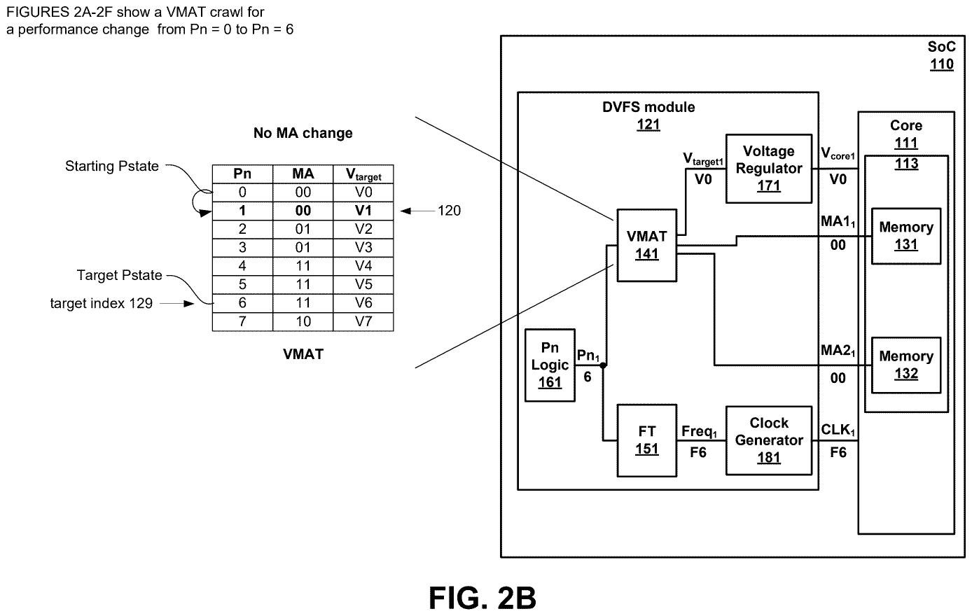

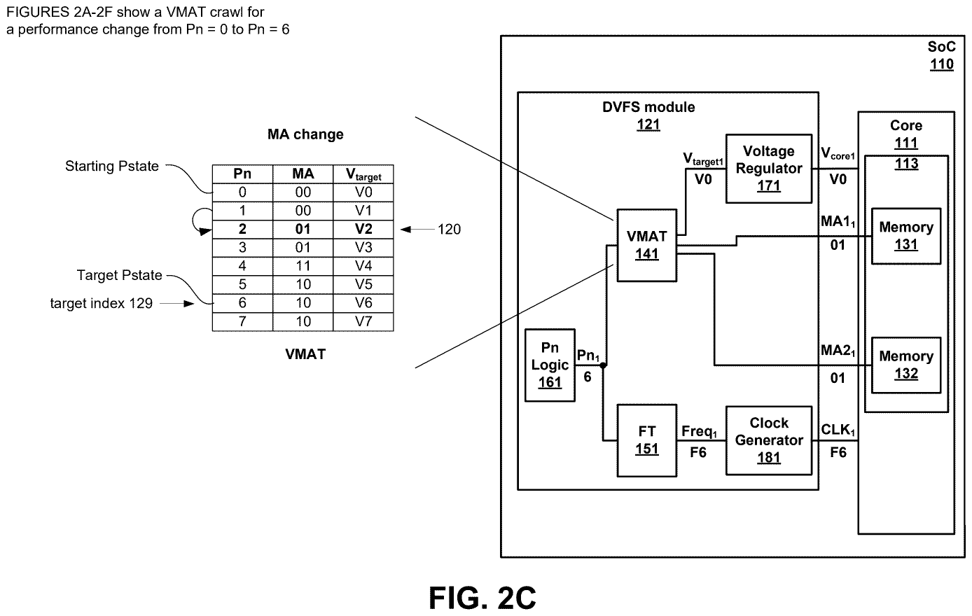

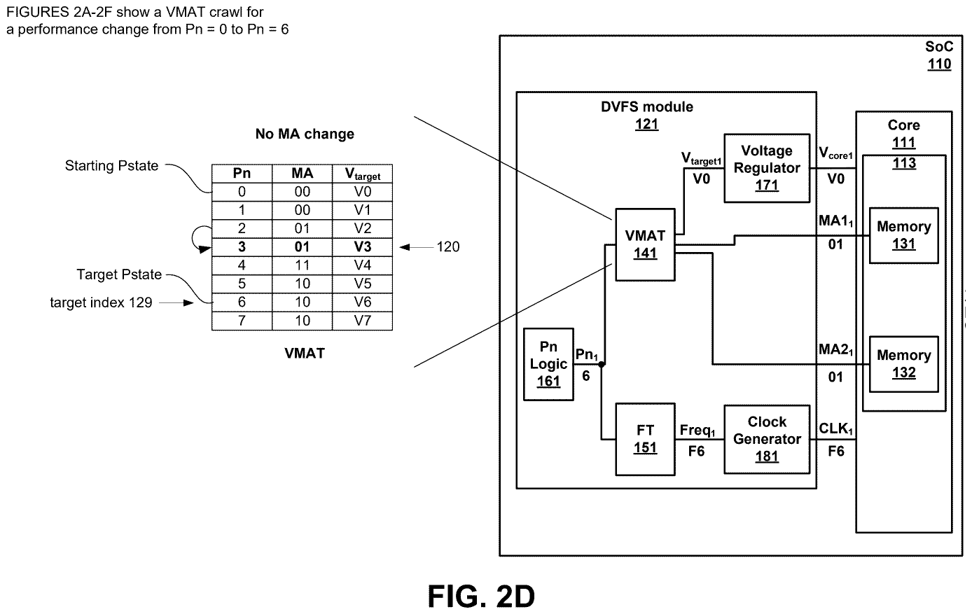

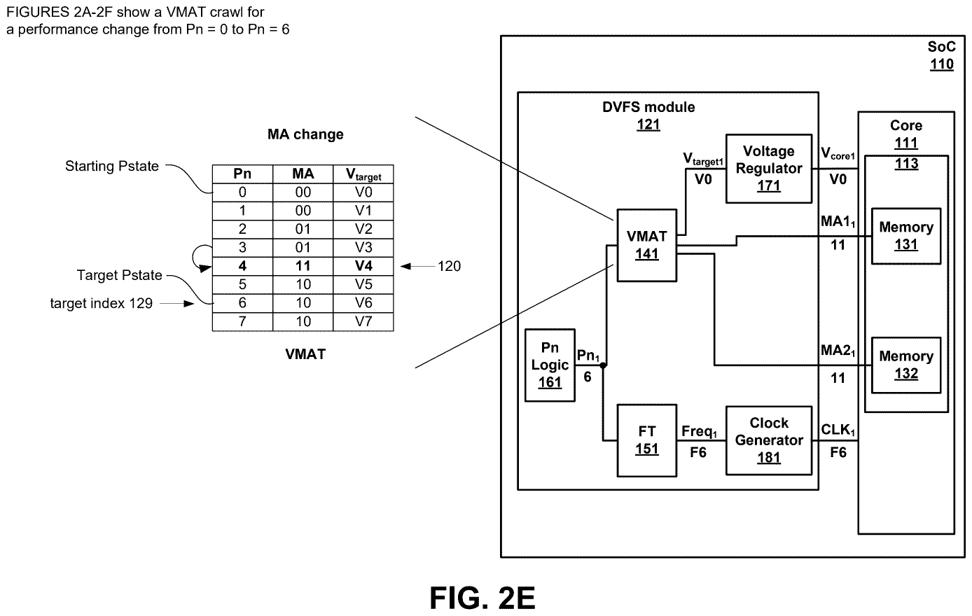

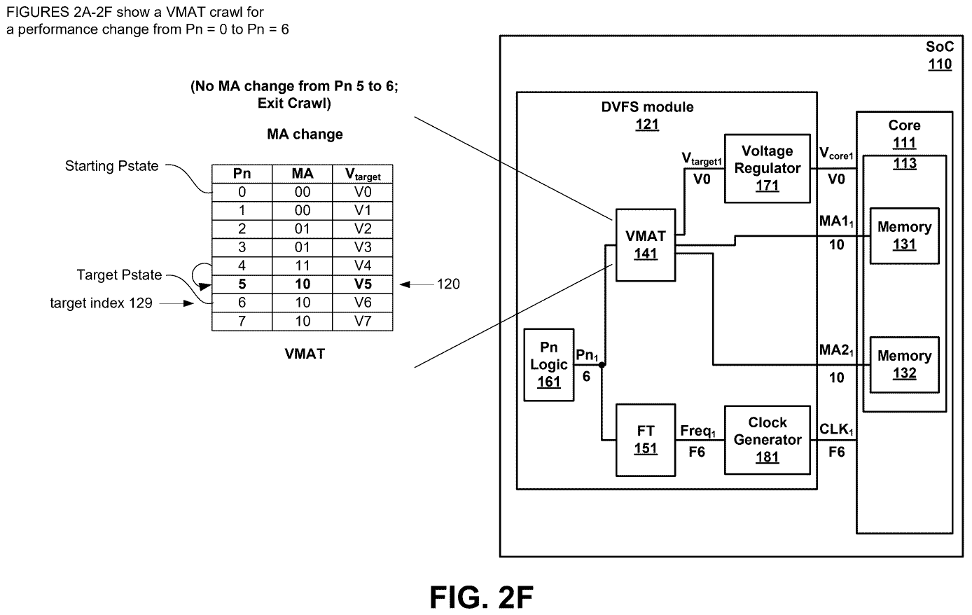

Referring now to FIGS. 2A-2F, aspects of the VMAT crawl mode are shown and described below. FIGS. 2A-2F show block diagrams of an SoC (110) that uses a programmable memory assist configuration and a VMAT crawl, illustrating an example of a VMAT crawl from Pn 0 to Pn 6.

In this example, the VMAT crawl mode is used during a performance state transition from a starting performance state to a target performance state. During the VMAT crawl mode, a target index 129 points to the target performance state in the VMAT 141. The target index 129 does not change during the VMAT crawl mode. Also, during the VMAT crawl mode, the DVFS module 121 creates a pointer index 120. The pointer index 120 points to a specific Pn in the VMAT 141 at a given point in time as the pointer index 120 crawls through each Pn during the VMAT mode crawl. The Pn that the pointer index 120 points to is referred to herein as the “crawling performance number” or “the crawling Pn.”

The pointer index 120 begins at the starting performance state, and crawls through the performance states without necessarily entering each state. The performance index 120 crawls through each interim performance state until the pointer index 120 reaches the target performance state or the DVFS module 121 exits the VMAT crawl early. If the pointer index 120 reaches an interim performance state that has the same memory assist values as the target performance state, the DVFS module 121 exits the VMAT crawl early. For example, with reference to the table of FIG. 2A, the pointer index 120 begins at a starting performance state, Pn=0, and the pointer index 120 crawls through each interim performance state, Pn=1 through Pn=5, until the pointer index 120 reaches the target performance state, Pn=6, or the DVFS module 121 exits the VMAT crawl early when the interim performance state has the same memory assist values as the target performance state. In this example, the DVFS module 121 exits the VMAT crawl early since the performance state, Pn=5, has the same memory assist values as the performance state, Pn=6.

During the VMAT crawl mode, the pointer index 120 is incrementally updated and crawls through each performance state, moving in the direction from the starting performance state to the target performance state. If the Pn of the target performance state is greater than the Pn of the starting performance state, then the crawling Pn that the pointer index 120 points to is increased by one, one at a time, until the target performance state is reached, until and unless the crawl exits early. If, instead, the Pn of the target performance state is less than the Pn of the starting performance state, then the crawling Pn that pointer index 120 points to is decreased by one, one at a time, until the target performance state is reached, until and unless the crawl exits early.

As the pointer index 120 incrementally crawls through individual performance states from the starting performance state to the target performance state, the DVFS module 121 selectively changes the memory assist values (e.g., MA1₁ and MA2₁) when the DVFS module 121 detects a change in the memory assist values. Each time the pointer index 120 changes during the VMAT crawl mode, the DVFS module 121 looks up the memory assist values for the pointer index 120. If the memory assist values for the pointer index 120 have not changed since the preceding value of the pointer index 120, then the DVFS module 121 does not change the memory assist values (e.g., MA1₁ and MA2₁). If, instead, the memory assist values for the pointer index 120 have changed since the preceding value of the pointer index 120, then DVFS module 121 drives out the memory assist values (e.g., MA1₁ and MA2₁) for the pointer index 120 after a configurable delay.

Once the pointer index 120 reaches a performance state that has the same memory assist values as the target performance state, the VMAT crawl mode ends. After the VMAT crawl mode ends, DVFS module 121 continues to provide the same memory assist values to the memories until the next performance state change.

In some configurations, the memory assist signaling is provided to just one memory, or to multiple memories of the same type, with the same memory assist signaling sent to each of the memories. In other configurations, the memory assist signaling is provided to multiple different memories of multiple different types, in which the memory assist values for some of the memories are different from the memory assist values for some of the other memories. In some embodiments, different memories of different types have memory assist values that are independent of each other in terms of when the memory assist values change. In these configurations, the memory assist values are considered to have changed if the memory assist values to any of the memories in the core have changed.

In the embodiment illustrated in FIGS. 2A-2F, a lower Pn indicates a performance state with greater performance. However, in other embodiments, other suitable relationships exist between the Pn of the performance state and the level of performance of that state. For instance, in some embodiments, a higher Pn indicates a performance state with greater performance.

FIGS. 2A-2F illustrate an embodiment of a VMAT crawl for a performance state change from Pn=0 to Pn=6. FIG. 2A illustrates the SoC 110 at the beginning of the VMAT crawl. Because the performance change is from a higher performance to a lower performance, the target clock frequency Freq1 and the clock signal CLK₁ have already been lowered from a frequency of F0 to a frequency of F6 prior to the VMAT crawl. Also, because the performance change is from a higher performance to a lower performance, the voltage level remains at the starting voltage level until after the VMAT crawl is completed.

The target index 129 in the VMAT 141 points to the Pn of the target performance state, which is 6 in this case. At the beginning of the VMAT crawl, the pointer index 120 is created. Initially, the pointer index 120 points to the Pn of the starting performance state, which, in this case, is 0. At the beginning of the VMAT crawl, the target voltage V_{target1} and the memory assist bits MA are provided according to the starting performance state. As illustrated in FIG. 2A, as indicated by the VMAT 141, for Pn=0, V_{target1}=V0, which is the highest voltage level for the core voltage, since Pn 0 represents the performance state with the highest level of performance. The memory assist bits MA are 00, which is the minimum level of memory assistance. For instance, in some embodiments, no memory assistance is used at Pn=0. As also illustrated in FIG. 2A, as indicated by the VMAT 141, for Pn=0, V_{core1}=V0, MA1₁=00, and MA2₁=00.

Next, the pointer index 120 is incrementally changed in the direction of the target performance state, one at a time. The performance state change is from 0 to 6, so the first incremental change in the pointer index 120 is a Pn change from 0 to 1. The incremental change of the pointer index 120 from a Pn of 0 to 1 is illustrated in FIG. 2B. As shown in the VMAT 141 in FIG. 2B, the value of the memory assist bits (MA) for Pn=1 is 00, which is the same as at Pn=0. Because the memory assist value does not change from Pn=0 to Pn=1, the memory assist values (MA1₁ and MA2₁) output by the VMAT 141 are unchanged from the values shown in FIG. 2A.

Next, as illustrated in FIG. 2C, the pointer index 120 is incremented from a Pn of 1 to 2. As shown in the VMAT 141 in FIG. 2C, the value of the memory assist bits (MA) for Pn=2 is 01, which is a change from the value of 00 at Pn=1. Because the memory assist value has changed, the VMAT 141 provides updated values for the memory assist values provided to each of the memories (e.g., the first memory 131 and the second memory 132) after a configurable delay. As shown in FIG. 2C, the updated memory assist values MA1₁ provided by the VMAT 141 to the first memory 131 are updated to 01. Likewise, the updated memory assist values MA2₁ provided by the VMAT 141 to the second memory 132 are updated to 01.

Next, as illustrated in FIG. 2D, the pointer index 120 is incremented from a Pn of 2 to 3. As shown in the VMAT 141 in FIG. 2D, the value of the memory assist bits (MA) for Pn=3 is 01, which is unchanged from the value of 01 at Pn=2. Because the memory assist value does not change from Pn=2 to Pn=3, the memory assist values output by the VMAT 141 are unchanged from the values shown in FIG. 2C.

Next, as illustrated in FIG. 2E, the pointer index 120 is incremented from a Pn of 3 to 4. As shown in the VMAT 141 in FIG. 2E, the value of the memory assist bits (MA) for Pn=4 is 11, which is a change from the value of 01 at Pn=3. Because the memory assist value has changed, the VMAT 141 provides updated values for the memory assist values provided to each of the memories (e.g., the first memory 131 and the second memory 132) after a configurable delay. The updated memory assist values MA1ᵢ provided by the VMAT 141 to the first memory 131 are updated to 11. Likewise, the updated memory assist values MA2₁ provided by the VMAT 141 to the second memory 132 are updated to 11.

Next, as illustrated in FIG. 2F, the pointer index 120 is incremented from 4 to 5. As shown in the VMAT 141 in FIG. 2F, the value of the memory assist bits (MA) for Pn=5 is 10, which is a change from the value of 11 at Pn=4. Because the memory assist value has changed, the VMAT 141 provides updated values for the memory assist values provided to each of the memories (e.g., 131 and 132) after a configurable delay. As shown in FIG. 2F, the updated memory assist values MA1₁ provided by the VMAT 141 to the first memory 131 are updated to 10. Likewise, the updated memory assist values MA2₁ provided by the VMAT 141 to the second memory 132 are updated to 10.

The memory assist value does not change from Pn=5 to Pn=6, where Pn=6 is the Pn of the final performance state for the performance state change from Pn=0 to Pn=6. Because there is no further change in the memory assist value for the performance state change, the VMAT crawl is now exited early. The VMAT crawl does not continue on to Pn=6. Although not part of the VMAT crawl itself, after the VMAT crawl ends, the target voltage V_{target1} is adjusted as needed for the final performance state Pn=6.

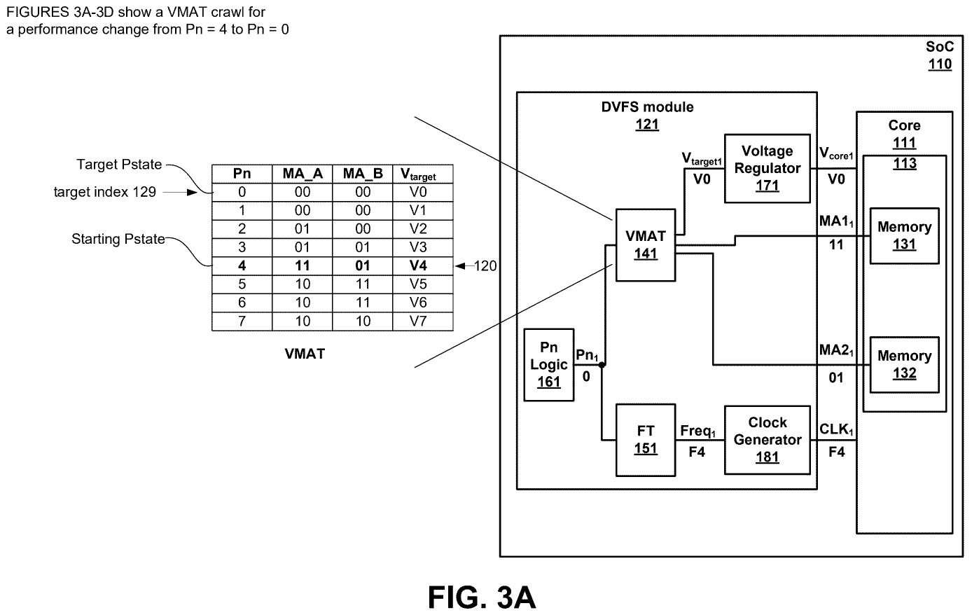

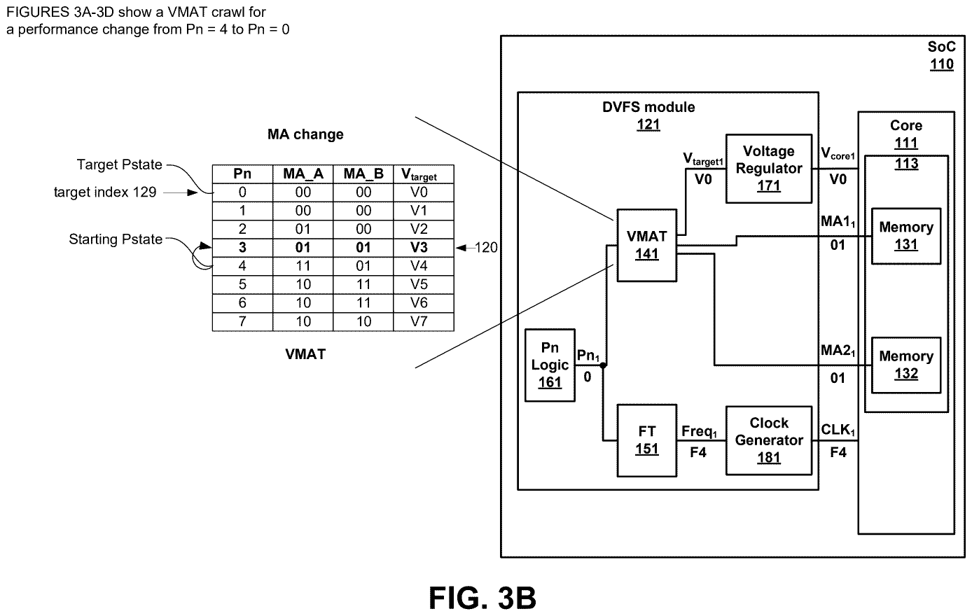

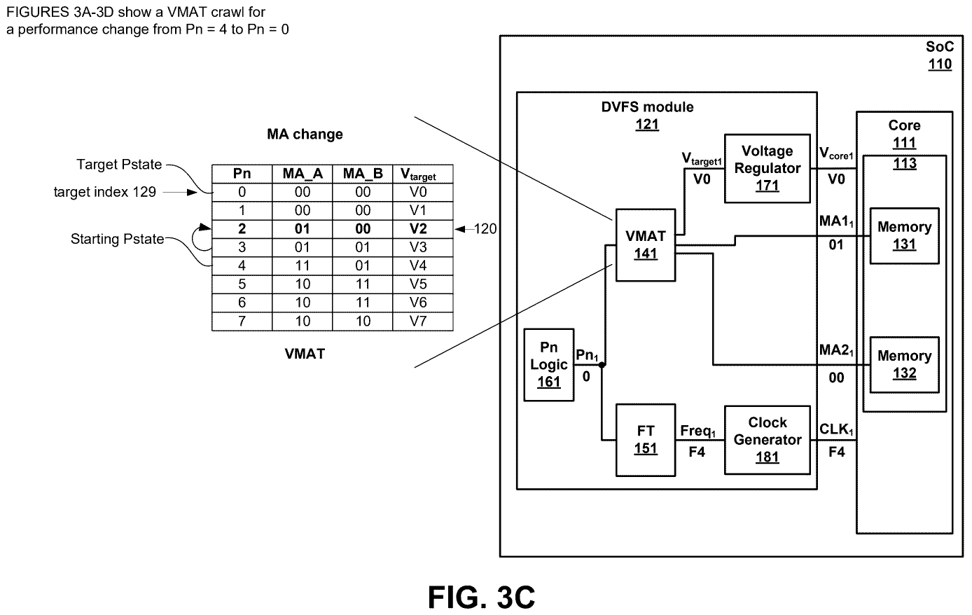

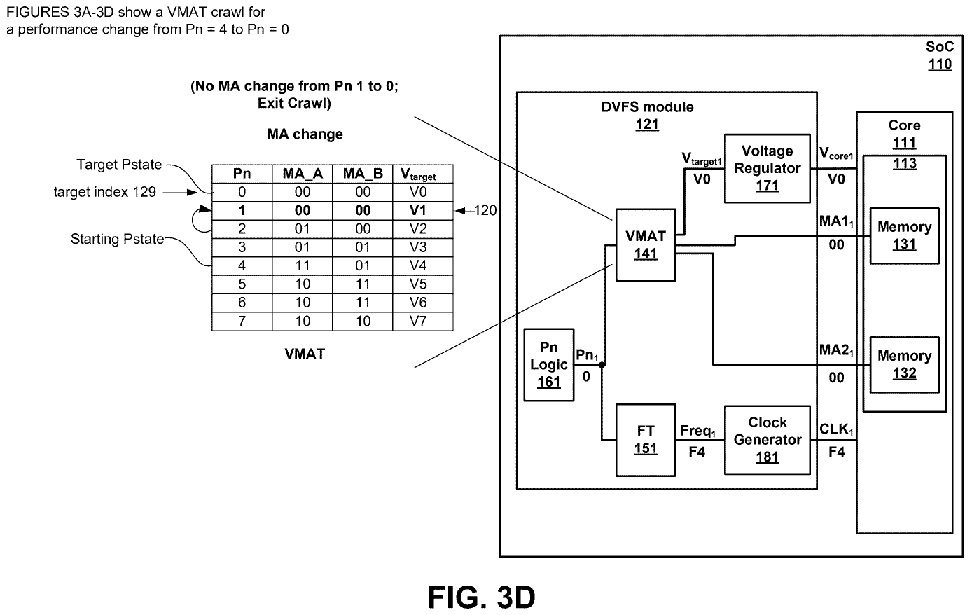

FIGS. 3A-3D illustrate an embodiment of a VMAT crawl for a performance state change from Pn=4 to Pn=0 in which the first memory 131 and the second memory 132 are different types of memory. FIG. 3A illustrates the SoC 110 at the beginning of the VMAT crawl. Because the performance change is from a lower performance to a higher performance, the target voltage V_{target1} and the core voltage V_{core1} have already been raised from a voltage of V4 to a voltage of V0 prior to the VMAT crawl. Also, because the performance change is from a lower performance to a higher performance, the clock frequency remains at the starting clock frequency until after the VMAT crawl is completed.

The target index 129 in the VMAT 141 points to the Pn of the target performance state, which is 0 in this case. At the beginning of the VMAT crawl, the pointer index 120 is created. Initially, the pointer index 120 points to the Pn of the starting performance state, which, in this case, is 4. Also, at the beginning of the VMAT crawl, the target clock frequency Freq₁ and the memory assist bits MA are provided according to the starting performance state.

As illustrated in FIG. 3A, as indicated by the VMAT 141, for Pn=4, MA_A=11, and MA_B=01. The first memory assist bits MA_A are for the first memory 131, and the second memory assist bits MA_B are for the second memory 132. Also, as illustrated in FIG. 3A, as indicated by the FT 151, for Pn=4, Freq₁=F4 and the clock signal CLK₁ is provided at a clock frequency of F4.

Next, the pointer index 120 is incremented in the direction of the performance state change, one Pstate at a time. The performance state change is from 4 to 0, so the first incremental change in the pointer index 120 is from a Pn of 4 to 3. The incremental change of the pointer index 120 from a Pn of 4 to 3 is illustrated in FIG. 3B. As shown in the VMAT 141 in FIG. 3B, the value of the first memory assist bits (MA_A) for Pn=3 is 01, which is a change from the value of 11 at Pn=4. The value of the second memory assist bits (MA_B) for Pn=3 is 01, which is unchanged. Because the memory assist value has changed for at least one of the memories, the VMAT 141 provides updated values for the memory assist values provided to each of the memories that has changed (e.g., the first memory 131) after a configurable delay. The updated memory assist values MA1₁ provided by the VMAT 141 to the first memory 131 are updated to 01. Because the second memory assist values MA_B have not changed, the memory assist values MA2₁ provided by the VMAT 141 to the second memory 132 are unchanged.

Next, as illustrated in FIG. 3C, the pointer index 120 is decremented from a Pn of 3 to 2. As shown in the VMAT 141 in FIG. 3C, the value of the memory assist bits (MA_A) for Pn=2 is 01, which is the same as at Pn=3. The value of the memory assist bits (MA_B) for Pn=2 is 00, which is a change from the previous values of 01. Because the memory assist value has changed for at least one of the memories, the VMAT 141 provides updated values for the memory assist values provided to each of the memories that has changed (e.g., the second memory 132) after a configurable delay. Because the first memory assist values MA_A have not changed, the memory assist values MA1₁ are unchanged. The updated memory assist values MA2₁ provided by the VMAT 141 to the second memory 132 are updated to 00.

Next, as illustrated in FIG. 3D, the pointer index 120 is decremented from a Pn of 2 to 1. As shown in the VMAT 141 in FIG. 3D, the value of the first memory assist bits (MA_A) for Pn=1 is 00, which is a change from the value of 01 at Pn=2. The value of the second memory assist bits (MA_B) for Pn=1 is 00, which is unchanged. Because the memory assist value has changed for at least one of the memories, the VMAT 141 provides an updated value for the memory assist values provided to each of the memories that has changed (e.g., the first memory 131) after a configurable delay. The updated first memory assist values MA1₁ provided by the VMAT 141 to the first memory 131 are updated to 00. Because the second memory assist values MA_B have not changed, the memory assist values MA2₁ provided by the VMAT 141 to the second memory 132 are unchanged.

The memory assist values (MA_A and MA_B) do not change from Pn=1 to Pn=0, where Pn=0 is the Pn of the final performance state for the performance state change from Pn=4 to Pn=0. Because there is no further change in the memory assist value for the performance state, the VMAT crawl is now exited early. The VMAT crawl does not continue on to Pn=0. Although not part of the VMAT crawl itself, after the VMAT crawl ends, the target frequency Freq₁ is adjusted as needed for the final performance state Pn=0.

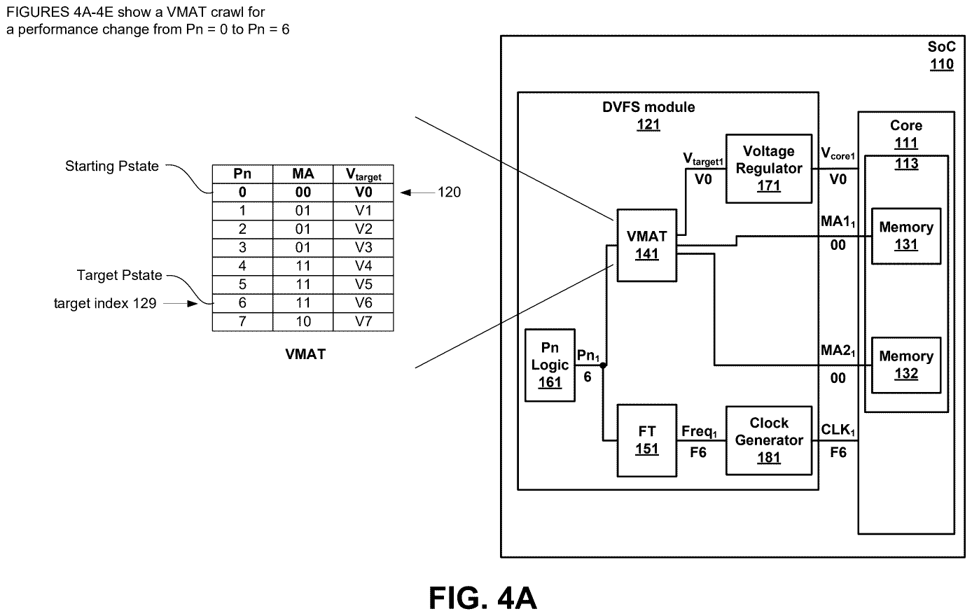

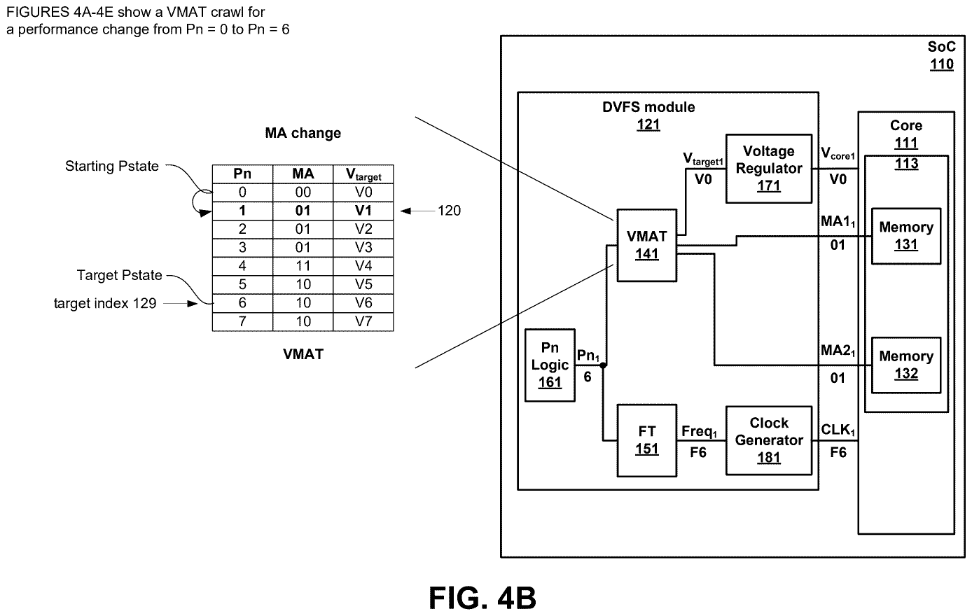

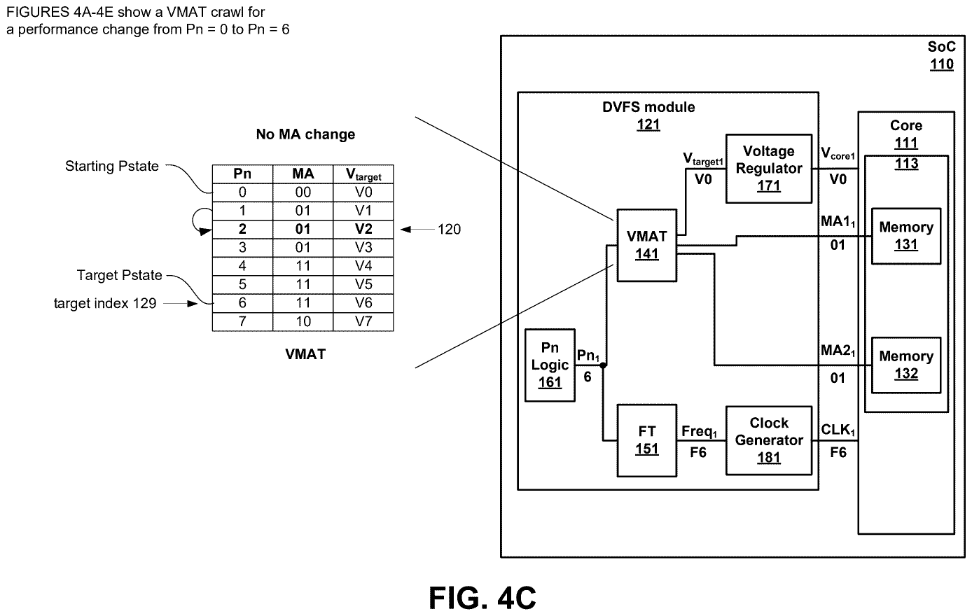

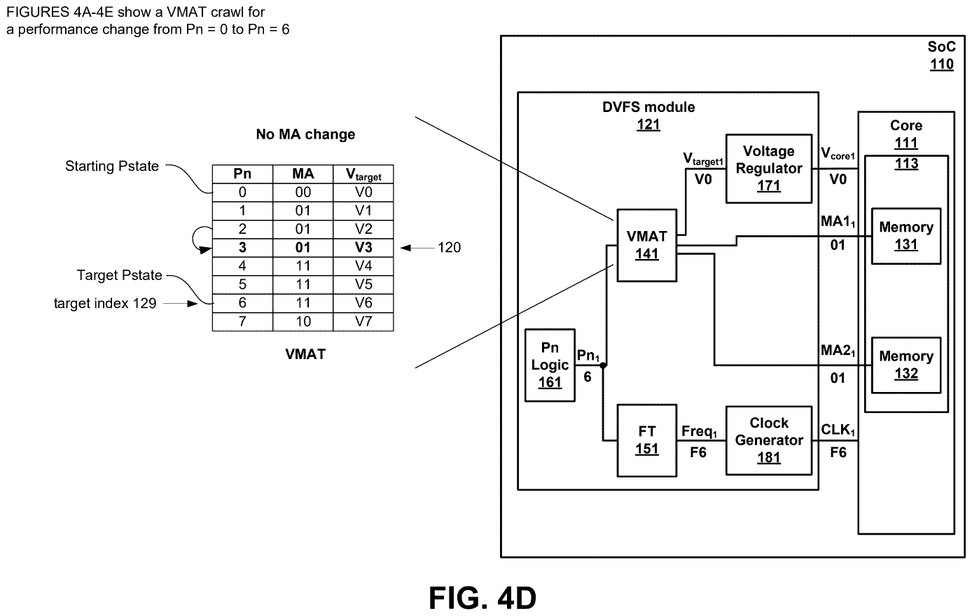

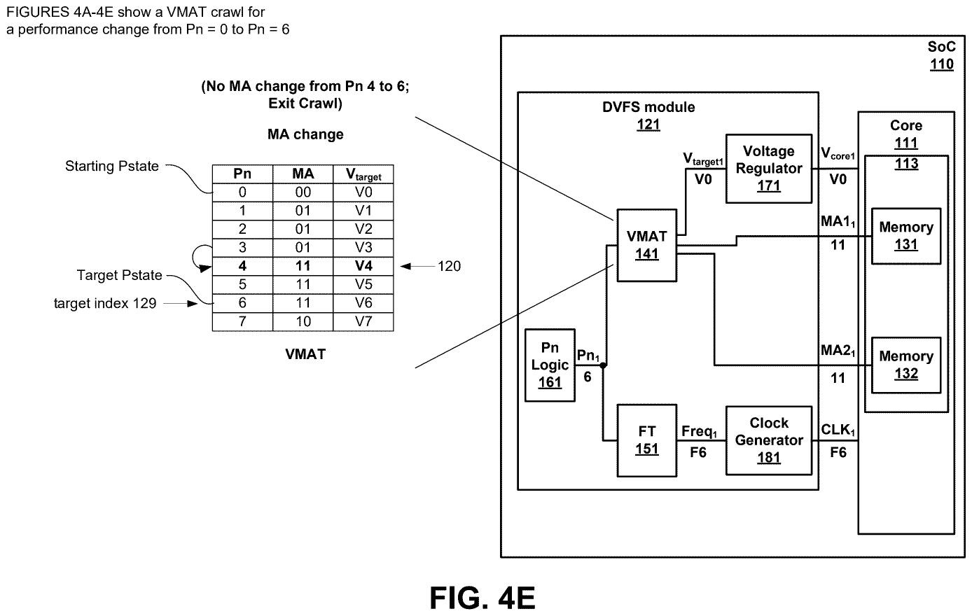

FIGS. 4A-4E illustrate an embodiment of a VMAT crawl for a performance state change from Pn=0 to Pn=6. This embodiment is much like FIGS. 2A-2F, which also illustrate an embodiment of a VMAT crawl for a performance state change from Pn=0 to Pn=6. The difference is that the embodiment of FIGS. 4A-4E uses different memory assist values than the embodiment in FIG. 2A-2F, thus giving an example of how a VMAT crawl for the same performance state change may be different with different memory assist values.

FIG. 4A illustrates the SoC 110 at the beginning of the VMAT crawl. Because the performance change is from a higher performance to a lower performance, the target clock frequency Freq₁ and the clock signal CLK₁ have already been lowered from a frequency of F0 to a frequency of F6 prior to the VMAT crawl. Also, because the performance change is from a higher performance to a lower performance, the voltage level remains at the starting voltage level until after the VMAT crawl is completed.

The target index 129 in the VMAT 141 points to the Pn of the target performance state, which is 6 in this case. At the beginning of the VMAT crawl, the pointer index 120 is created. Initially, the pointer index 120 points to the Pn of the starting performance state, which, in this case, is 0. Also, at the beginning of the VMAT crawl, the target voltage V_{target1} and the memory assist bits MA are provided according to the starting performance state. As illustrated in FIG. 4A, as indicated by the VMAT 141, for Pn=0, V_{target1}=V0, V_{core1}=V0, MA1₁=00, and MA2₁=00.

Next, the pointer index 120 is incremented in the direction of the performance state change, one at a time. The performance state change is from 0 to 6, so the first incremental change in the pointer index 120 is from a Pn of 0 to 1. The incremental change of the pointer index 120 from a Pn of 0 to 1 is illustrated in FIG. 4B. As shown in the VMAT 141 in FIG. 4B, the value of the memory assist bits (MA) for Pn=1 is 01, which is a change from the value of 00 at Pn=0. Because the memory assist value has changed, the VMAT 141 provides updated values for the memory assist values provided to each of the memories (e.g., memory 131 and memory 132) after a configurable delay. As shown in FIG. 4B, the memory assist values MA1₁ provided by the VMAT 141 to the first memory 131 are updated to 01. Likewise, the memory assist values MA2₁ provided by the VMAT 141 to the second memory 132 are updated to 01.

Next, as illustrated in FIG. 4C, the pointer index 120 is incremented from a Pn of 1 to 2. As shown in the VMAT 141 in FIG. 4C, the value of the memory assist bits (MA) for Pn=2 is 01, which is the same as at Pn=1. Because the memory assist value does not change from Pn=1 to Pn=2, the memory assist values output by the VMAT 141 are unchanged from the values shown in FIG. 4B.

Next, as illustrated in FIG. 4D, the pointer index 120 is incremented from a Pn of 2 to 3. As shown in the VMAT 141 in FIG. 4D, the value of the memory assist bits (MA) for Pn=3 is 01, which is the same as at Pn=2. Because the memory assist value does not change from Pn=2 to Pn=3, the memory assist values output by the VMAT 141 are unchanged from the values shown in FIG. 4B or FIG. 4C.

Next, as illustrated in FIG. 4E, the pointer index 120 is incremented from a Pn of 3 to 4. As shown in the VMAT 141 in FIG. 4E, the value of the memory assist bits (MA) for Pn=4 is 11, which is a change from the value of 01 at Pn=3. Because the memory assist value has changed, the VMAT 141 provides updated values for the memory assist values provided to each of the memories (e.g., the first memory 131 and the second memory 132) after a configurable delay. The updated memory assist values MA1₁ provided by the VMAT 141 to the first memory 131 are updated to 11. Likewise, the updated memory assist values MA2₁ provided by the VMAT 141 to the second memory 132 are updated to 11.

The memory assist value does not change from Pn=4 to Pn=6, where Pn=6 is the Pn of the final performance state for the performance state change from Pn=0 to Pn=6. Because there is no further change in the memory assist value for the performance state, the VMAT crawl is now exited early. The VMAT crawl does not continue on to Pn=6. Although not part of the VMAT crawl itself, after the VMAT crawl ends, the target voltage V_{target1} is adjusted as needed for the final performance state Pn=6.

As discussed above, during the VMAT crawl mode, the memory assist values provided to the memories are updated after a configurable delay each time the memory assist values change. Because Gray coding is used for the memory assist values, each transition of the memory assist values is a single-bit transition. As discussed above, the single-bit transitions across the clock boundary between the DVFS module and the memories avoid metastability and timing failures with the crossing of the clock boundary.

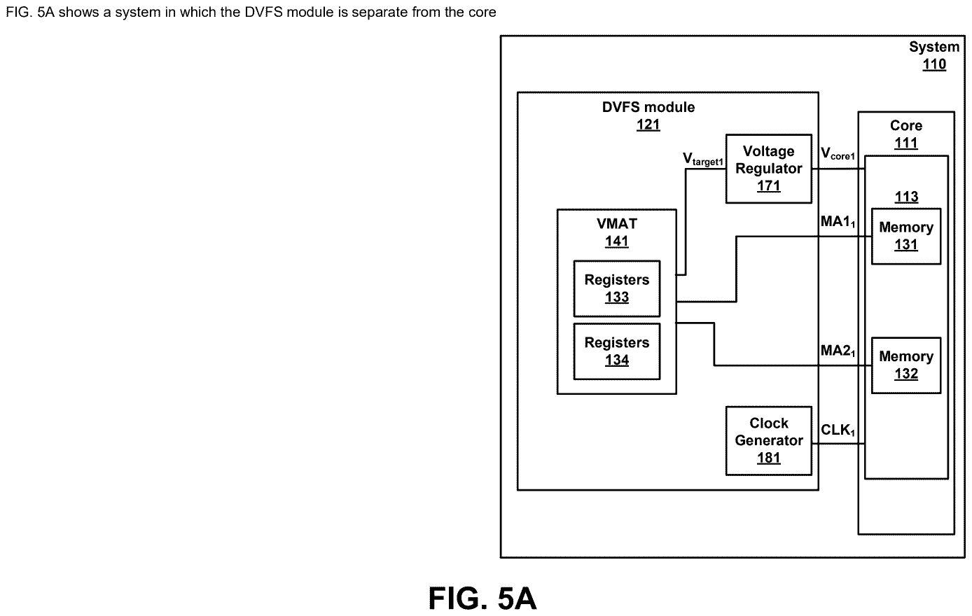

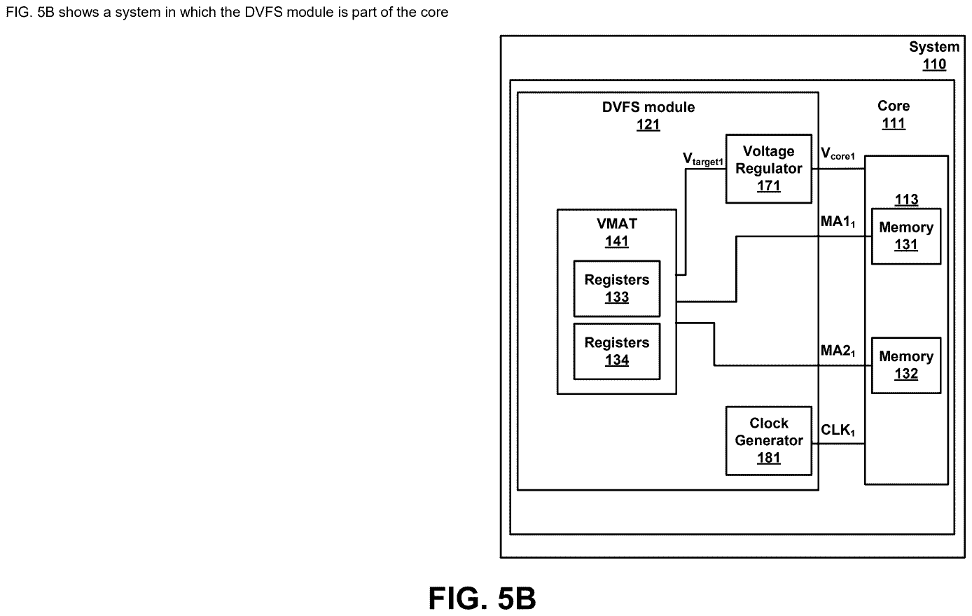

FIG. 5A and FIG. 5B show that the DVFS module may be part of the core or separate from the core. More specifically, FIG. 5A shows an example of the system 110 in which the DVFS module 121 is separate from the core 111. FIG. 5B shows an example of the system 110 in which the DVFS module 121 is part of the core 111.

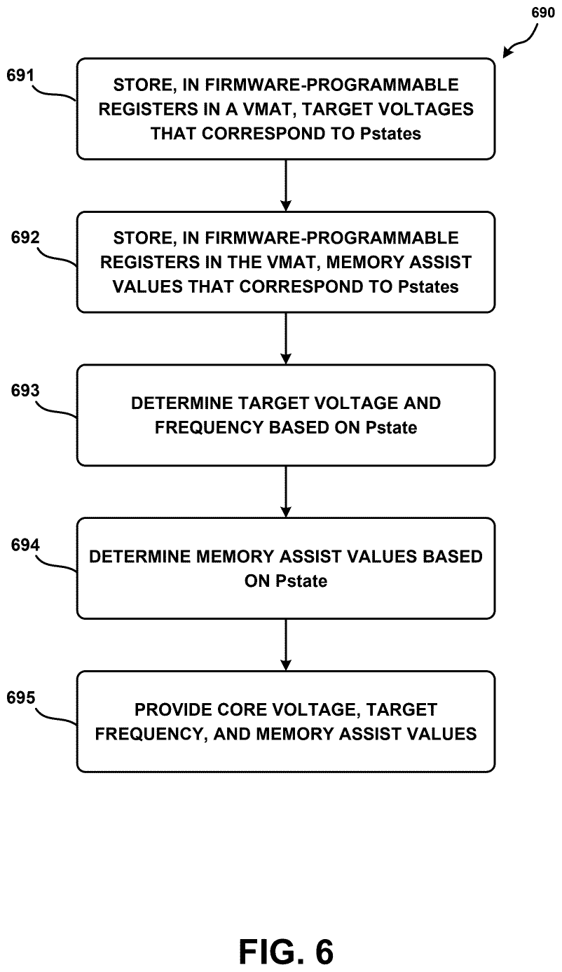

FIG. 6 shows a flow chart illustrating an embodiment of a process 690 for firmware-programmable memory assist configuration. The process may be implemented in one of the systems, or portion thereof, of any of the previous figures.

The process 690 starts at operation 691, where, in a first plurality of firmware-programmable registers in a first VMAT, target voltages that correspond to performance states are stored. Operation 691 may be followed by operation 692. At operation 692, in a second plurality of firmware-programmable in the first VMAT, memory assist values that correspond to the performance states are stored. Operation 692 may be followed by operation 693. At operation 693, during a performance state change from a starting performance state to a target performance state: the first plurality of firmware-programmable registers (133) and a frequency table (151) are accessed to determine, respectively, a target voltage (V_{target1}) among the targets voltages that correspond to the target performance state and a target frequency (Freq₁). Operation 693 may be followed by operation 694.

At operation 694, the second plurality of firmware-programmable registers (134) is accessed to determine memory assist values among the memory assist values (MA) that correspond to the target performance state or an intermediate performance state. Operation 694 may be followed by operation 695. At operation 695, a first core voltage (V_{core1}) is provided to a first plurality of memories (131, 132) on a first core (111), such that the first core voltage (V_{core1}) is provided based on the determined target voltage (V_{target1}). Also, at operation 695, the memory assist signaling is provided to the first plurality of memories (131, 132), such that the memory assist signaling is provided based on the determined memory assist values. The order in which the core voltage and the target frequency are provided and the memory assist signal is provided depends on whether the core voltage is being increased or decreased. In the case of a performance decrease, frequency is reduced before the memory assist values are provided. In the case of a performance increase, the voltage is raised before the memory assist values are provided.

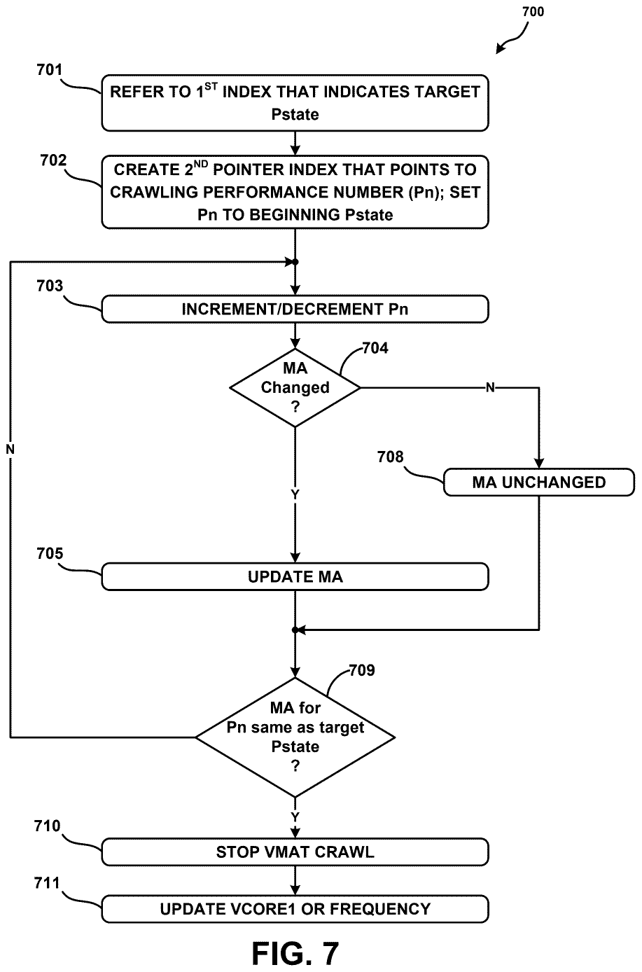

FIG. 7 shows a flow chart illustrating an embodiment of a process 700 for a VMAT crawl. The described processes and methods may be implemented in one of the systems, or portion thereof, of any of the previous figures. In some embodiments, the steps of process 700 are performed in addition to steps of process 690 of FIG. 6, which, together, provides a process for firmware-programmable memory assist configuration and a VMAT crawl. Processing for various described processes and methods may commence at operation 701.

At operation 701, during a performance state change from a starting performance state to a target performance state, a target index is referenced. The performance numbers are associated with the performance states. The target index is associated with a target performance number among the performance numbers that indicates the target performance state. Operation 701 may be followed by operation 702. At operation 702, a pointer index into the VMAT is created such that the pointer index points to a crawling performance number. Also, the pointer index is created such that the crawling performance number is adjustable. Additionally, the pointer index is created such that, at the beginning of the performance state change, the crawling performance number is a performance number among the performance numbers that indicates the starting performance state. Operation 702 may be followed by operation 703. Operations 703-710 illustrate an embodiment of a VMAT crawl.

At operation 703, the crawling performance number is incrementally changed. For instance, in some embodiments, if the performance number of the target performance state is greater than the performance number current performance state, the crawling performance number is incremented by one, and if the performance number of the target performance state is less than the performance number current performance state, the crawling performance number is decremented by one. Operation 703 may be followed by decision operation 704. At decision operation 704, it is determined whether the memory assist values associated with the indexed performance state among the performance states that is associated with the crawling performance number have changed. If the determination at decision operation 704 is positive (i.e., the memory assist values have changed), the process proceeds from decision operation 704 to operation 705. At operation 705, using Gray encoding, memory assist signaling is provided to the first plurality of memories, such that the memory assist signaling is provided based on the memory assist values that correspond to the performance state that is associated with the crawling performance number. Operation 705 may be followed by decision operation 709.

If, instead, the determination at decision operation 704 is negative (i.e., the memory assist values have not changed), the process advances from decision operation 704 to operation 708. At operation 708, memory assist signaling is provided to the first plurality of memories in the same manner as prior to the incremental change (i.e., the memory assist signaling remains unchanged). Operation 708 may be followed by decision operation 709.

Either way, at decision operation 709, it is determined whether the memory assist values associated with the performance state among the performance states that is associated with the crawling performance number and the memory assist values associated with the target performance state are the same. If the determination as decision operation 709 is positive (i.e., the memory assist values are the same as the target), the process then proceeds to operation 710. At operation 710, the crawling of the VMAT is stopped. If, instead, the determination at decision operation 709 is negative (i.e., the memory assist values are not the same as the target), the process instead moves to operation 703. Operation 710 may be followed by operation 711. At operation 711, the core voltage or the clock frequency is updated based on the target performance state. More specifically, if the performance change is from a lower performance to a higher performance, the clock frequency is raised at operation 711. If instead the performance change is a performance change from a higher performance to a lower performance, the core voltage is lowered at operation 711.

The term “VMAT crawl mode” or “crawling through the VMAT” refers to the actions of operations 703-710 above, where a pointer index is created, the pointer index is incrementally changed, and the output values begin driven by the VMAT are altered at performance states for which the memory assist values have changed.

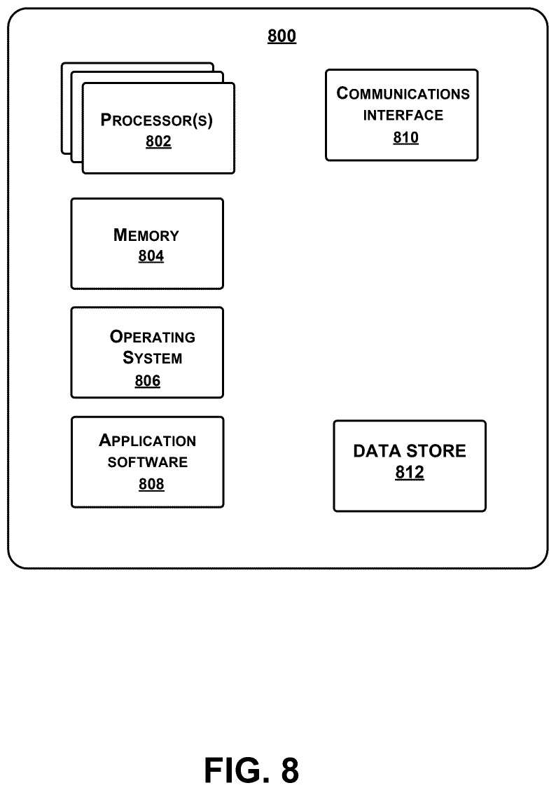

FIG. 8 illustrates various components of an exemplary computing-based device 800 which are implemented as any form of a computing and/or electronic device. In some embodiments, computing-based device 800 is a general-purpose computer that is activated or reconfigured by a computer program stored in the computer. In other embodiments computing-based device 800 is specially constructed for the intended purpose. In some embodiments, computing device 800 is a microprocessor used in embedded systems applications or other suitable applications. Processor(s) 802 may be employed as embodiments of the cores 111 and 112 of FIG. 1A-1C, 2A-2F, 3A-3D, 4A-4E, 5A, or 5B. Memory 804 may be employed as an embodiment of the first memory 131, the second memory 132, the third memory 136, or the fourth memory 137 of FIG. 1A-1C, 2A-2F, 3A-3D, 4A-4E, 5A, or 5B.

Computing-based device 800 comprises one or more processors 802 which are microprocessors, controllers or any other suitable type of processors for processing computer executable instructions to control the operation of the device. The processors 802 may include at least one general-purpose processing device such as a central processing unit, microprocessor, complex instruction set computing (CISC) microprocessor, reduced instruction set computing (RISC) microprocessor, or other general-purpose processing device. In some embodiments, for example where a system on a chip architecture is used, the processors 802 include one or more special-purpose processing device such as a fixed function block. The special-purpose processing device may be configured to execute instructions for performing the operations and methods described herein. Platform software comprising an operating system 806 or any other suitable platform software is provided at the computing-based device to enable application software 808 to be executed on the device. Data store 812 holds system prompts, context, boot code and other data.

The computer executable instructions are provided using any computer-readable media that is accessible by computing-based device 800. Computer-readable media includes, for example, computer storage media such as memory 804 and communications media. Computer storage media, such as memory 804, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital video disks (DVD) or other optical storage, magnetic cassettes, magnetic tape, magnetic disk storage or other magnetic storage devices, or any other non-transmission medium that is used to store information for access by a computing device.

In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 804) is shown within the computing-based device 800 it will be appreciated that the storage is, in some embodiments, distributed or located remotely and accessed via a network or other communication link (e.g. using communication interface 810). The computing-based device is able to communicate with other bots and communications network nodes via communications interface 810. For illustrative purposes, “registers,” “programmable registers,” or “firmware-programmable registers” described herein are “programmable,” meaning that the register's behavior or contents can be modified through software instructions without the need to reconfigure any hardware components. This allows the register to be used for various purposes depending on the needs of the system or an associated core. Programmable registers are used for the system disclosed herein for voltages and frequencies related to Pstates, and those settings that can be changed dynamically during the execution of a software program.

In some examples, one or more of the defined parameters, such as the target voltages stored in a VMAT, may vary as defined by other monitored parameters. For instance, in some examples, at a particular performance state, more than one target voltage may be used depending on one or more other monitored parameters.

Although various embodiments discussed above have included two memories in a core, it will be appreciated that the disclosed techniques can be applied to a core with any suitable number of memories, e.g., one memory, three memories, etc.

The number of performance states is different in different embodiments. For instance, in some examples, there are 32 performance states. However, other suitable numbers of performance states are used in various examples. For instance, in some examples, there are 2 performance states, 4 performance states, 8 performance states, 16 performance states, 64 performance states, 128 performance states, or more than 128 performance states. Also, although in some examples the number of performance states is a power of two, in other examples, a suitable number of performance states that is not a power of two is used.

The disclosure presented herein also encompasses the subject matter set forth in the following clauses:

Example Clause A: A method for transitioning a system from a first performance state to a second performance state, the method comprising: storing, in a first plurality of firmware-programmable registers (133) in a first Voltage and Memory Assist Table (VMAT) (141), target voltages that correspond to performance states, wherein the performance states include the first performance state and the second performance state; storing, in a second plurality of firmware-programmable registers (134) in the first VMAT (141), memory assist values (MA) that correspond to the performance states, wherein the memory assist values (MA) are encoded with Gray encoding; during a performance state change from the first performance state to the second performance state: accessing the first plurality of firmware-programmable registers (133) to determine a target voltage (V_{target1}) among the targets voltages that corresponds to the second performance state; and accessing the second plurality of firmware-programmable registers (134) to determine memory assist values among the memory assist values (MA) that correspond to the second performance state; providing a first core voltage (V_{core1}) to a first plurality of memories (131, 132) on a first core (111), such that the first core voltage (V_{core1}) is provided based on the determined target voltage (V_{target1}) among the target voltages that corresponds to the second performance state; and providing memory assist signaling to the first plurality of memories (131, 132), such that the memory assist signaling is provided based on the determined memory assist values, wherein the first plurality of memories (131, 132) operate on a clock frequency that is asynchronous with the second plurality of firmware-programmable registers, wherein a clock boundary exists between the first plurality of memories and the second plurality of firmware-programmable registers, and wherein the Gray coding of the memory assist values creates single-bit transitions across the clock boundary.

Example Clause B: The method of any of the preceding clauses, further comprising: via firmware (109), changing the memory assist values (MA) stored in the second plurality of firmware-programmable registers (134) from a first set of memory assist values (MA′) to a second set of memory assist values (MA″); and after changing the memory assist values (MA): accessing the second plurality of firmware-programmable registers (134) to determine memory assist values among the second set of memory assist values (MA″); and providing memory assist signaling to the first plurality of memories (131, 132), such that the memory assist signaling is provided based on the memory assist values determined among the second set of memory assist values (MA″).

Example Clause C: The method of any of the preceding clauses, wherein at least one of the memory assist values (MA) is associated with at least one of a voltage level that is associated with at least one memory of the first plurality of memories (131, 132) or a timing parameter that is associated with at least one memory of the first plurality of memories (131, 132).

Example Clause D: The method of any of the preceding clauses, further comprising, during the performance state change: providing a clock signal (CLK₁) such that a frequency that is associated with the clock signal (CLK₁) is associated with the second performance state; referencing a target index (129), wherein performance numbers are associated with the performance states, and wherein the target index (129) is associated with a target performance number among the performance numbers that indicates the second performance state; creating a pointer index (120) into the VMAT (141) such that the pointer index (120) points to a crawling performance number (Pn), such that the crawling performance number (Pn) is adjustable, and such that, at a beginning of the performance state change, the crawling performance number (Pn) is a performance number among the performance numbers that indicates the first performance state; crawling the VMAT (141), wherein the crawling of the VMAT (141) comprises: incrementally stepping the crawling performance number (Pn); at each incremental change of the crawling performance number (Pn), determining whether the memory assist values (MA) associated with the performance state among the performance states that is associated with the crawling performance number (Pn) have changed; at each incremental change of the crawling performance number (Pn) at which it is determined that the memory assist values (MA) associated with the performance state among the performance states that is associated with the crawling performance number (Pn) have changed: using Gray encoding, providing memory assist signaling to the first plurality of memories (131, 132), such that the memory assist signaling is provided based on the memory assist values (MA) that correspond to the performance state that is associated with the crawling performance number (Pn); and at each incremental change of the crawling performance number (Pn) at which it is determined that the memory assist values (MA) associated with the performance state among the performance states that is associated with the crawling performance number (Pn) have not changed: maintaining the memory assist signaling to the first plurality of memories (131, 132); at each incremental change of the crawling performance number (Pn), determining whether the memory assist values (MA) associated with the performance state among the performance states that is associated with the crawling performance number (Pn) and the memory assist values (MA) associated with the second performance state are the same; and upon determining that the memory assist values (MA) associated with the performance state among the performance states that is associated with the crawling performance number (Pn) and the memory assist values (MA) associated with the second performance state are the same, stopping the crawling of the VMAT (141), wherein providing the first core voltage (V_{core1}) to the first plurality of memories (131, 132) on the first core (111) such that the first core voltage (V_{core1}) is provided based on the determined target voltage (V_{target1}) among the target voltages that corresponds to the second performance state is performed after crawling the VMAT.

Example Clause E: The method of any of the preceding clauses, wherein the performance number that is associated with the second performance state is greater than the performance number that is associated with the first performance state, and wherein incrementally stepping the crawling performance number (Pn) comprises incrementally increasing the crawling performance number (Pn).

Example Clause F: The method of any of the preceding clauses, wherein the performance number that is associated with the second performance state is less than the performance number that is associated with the first performance state, and wherein incrementally stepping the crawling performance number (Pn) comprises incrementally decrementing the crawling performance number (Pn).

Example Clause G: The method of any of the preceding clauses, wherein the first plurality of memories (131, 132) includes a first memory (131) and a second memory (132), and wherein the memory assist values (MA) include at least a first memory assist value (MA1₁) that is associated with the first memory (131) and a second memory assist value (MA2₁) that is associated with the second memory (132).

Example Clause H: The method of any of the preceding clauses, further comprising, during the performance state change: raising a voltage level of the first core voltage (Vcore1) provided to the first plurality of memories (131, 132) on the first core (111) from a first level associated with a first performance state to a second level associated with the second performance state, referencing a target index (129), wherein performance numbers are associated with the performance states, and wherein the target index (129) is associated with a target performance number among the performance numbers that indicates the second performance state; creating a pointer index (120) into the VMAT (141) such that the pointer index (120) points to a crawling performance number (Pn), such that the crawling performance number (Pn) is adjustable, and such that, at a beginning of the performance state change, the crawling performance number (Pn) is a performance number among the performance numbers that indicates the first performance state; crawling the VMAT (141), wherein the crawling of the VMAT (141) comprises: incrementally stepping the crawling performance number (Pn), at each incremental step of the crawling performance number (Pn), determining whether the memory assist values (MA) associated with the performance state among the performance states that is associated with the crawling performance number (Pn) have changed, at each incremental step of the crawling performance number (Pn) at which it is determined that the memory assist values (MA) associated with the performance state among the performance states that is associated with the crawling performance number (Pn) have changed: using Gray encoding, providing memory assist signaling to the first plurality of memories (131, 132), such that the memory assist signaling is provided based on the memory assist values (MA) that correspond to the performance state that is associated with the crawling performance number (Pn), and at each incremental step of the crawling performance number (Pn) at which it is determined that the memory assist values (MA) associated with the performance state among the performance states that is associated with the crawling performance number (Pn) have not changed: maintaining the memory assist signaling to the first plurality of memories (131, 132), at each incremental step of the crawling performance number (Pn), determining whether the memory assist values (MA) associated with the performance state among the performance states that is associated with the crawling performance number (Pn) and the memory assist values (MA) associated with the second performance state are the same, and upon determining that the memory assist values (MA) associated with the performance state among the performance states that is associated with the crawling performance number (Pn) and the memory assist values (MA) associated with the second performance state are the same, stopping the crawling of the VMAT (141), and, after crawling the VMAT, providing a clock signal (CLK₁) such that the clock signal is provided such that a frequency that is associated with the clock signal is provided such that the frequency is associated with the second performance state.

Example Clause I: An apparatus, comprising: a first dynamic voltage and frequency scaling (DVFS) module (121), comprising; a first Voltage and Memory Assist Table (VMAT) (141), comprising: a first plurality of firmware-programmable registers (133) that store target voltages that correspond to performance states, wherein the performance states include a first performance state and a second performance state; and a second plurality of firmware-programmable registers (134) that store memory assist values (MA) that correspond to the performance states wherein the memory assist values (MA) are encoded with Gray encoding; and a first domain (113) residing in a first core (111), the first domain (113) comprising a first plurality of memories (131, 132), wherein the first domain (113) operates on a clock frequency that is asynchronous with the first DVFS module (121), and wherein the first DVFS module (121) is configured to: during a performance state change from a first performance state to a second performance state: access the first plurality of firmware-programmable registers (133) to determine a target voltage (Vtarget1) among the targets voltages that corresponds to the second performance state; and access the second plurality of firmware-programmable registers (134) to determine memory assist values among the memory assist values (MA) that correspond to the second performance state; provide a first core voltage (Vcore1) to the first domain (113), such that the first core voltage (Vcore1) is provided based on the determined target voltage (V_{target1}); and provide memory assist signaling to the first plurality of memories (131, 132), such that the memory assist signaling is provided based on the determined memory assist values.

Example Clause J: The apparatus of Clause I, wherein the first DVFS module (121) is separate from the first core (111).

Example Clause K: The apparatus of any of Clauses I through J, wherein the first core (111) includes the first DVFS module (121).

Example Clause L: The apparatus of any of Clauses I through K, wherein at least one of the memory assist values (MA) is associated with at least one of a voltage level that is associated with at least one memory of the first plurality of memories (131, 132) or a timing parameter that is associated with at least one memory of the plurality of memories (131, 132).

Example Clause M: The apparatus of any of Clauses I through L, wherein the first DVFS module (121) includes a first voltage regulator (171) that is arranged to provide the first voltage (Vcore1) based on the target voltage (Vtarget1) among the target voltages that corresponds to the current performance state.

Example Clause N: The apparatus of any of Clauses I through M, further comprising a system control processor (SCP) (119), wherein the SCP (119) is arranged to execute firmware (109), and wherein the firmware (109) is arranged to change the memory assist values (MA) stored in the second plurality of firmware-programmable registers (134).

Example Clause O: The apparatus of any of Clauses I through N, wherein the first DVFS module (121) is further configured to, during the performance state change: provide a clock signal (CLK₁) such that a frequency that is associated with the clock signal (CLK₁) is associated with the second performance state; reference a target index (129), wherein performance numbers are associated with the performance states, and wherein the target index (129) is associated with a target performance number among the performance numbers that indicates the second performance state; create a pointer index (120) into the VMAT (141) such that the pointer index (120) points to a crawling performance number (Pn), such that the crawling performance number (Pn) is adjustable, and such that, at a beginning of the performance state change, the crawling performance number (Pn) is the performance number among the performance numbers that indicates the first performance state; crawl the VMAT (141), wherein the crawling of the VMAT (141) comprises: incrementally change the crawling performance number (Pn); at each incremental change of the crawling performance number (Pn), determine whether the memory assist values (MA) associated with the performance state among the performance states that is associated with the crawling performance number (Pn) have changed; at each incremental change of the crawling performance number (Pn) at which it is determined that the memory assist values (MA) associated with the performance state among the performance states that is associated with the crawling performance number (Pn) have changed: using Gray encoding, provide memory assist signaling to the first plurality of memories (131, 132), such that the memory assist signaling is provided based on the memory assist values (MA) that correspond to the performance state that is associated with the crawling performance number (Pn); and at each incremental change of the crawling performance number (Pn) at which it is determined that the memory assist values (MA) associated with the performance state among the performance states that is associated with the crawling performance number (Pn) have not changed: maintain the memory assist signaling to the first plurality of memories (131, 132) in the same manner as prior to the incremental change; at each incremental change of the crawling performance number (Pn), determine whether the memory assist values (MA) associated with the performance state among the performance states that is associated with the crawling performance number (Pn) and the memory assist values (MA) associated with the second performance state are the same; and upon determining that the memory assist values (MA) associated with the performance state among the performance states that is associated with the crawling performance number (Pn) and the memory assist values (MA) associated with the second performance state are the same, stopping the crawling of the VMAT (141), wherein providing the first core voltage (Vcore1) to the first plurality of memories (131, 132) on the first core (111) such that the first core voltage (Vcore1) is provided based on the determined target voltage (Vtarget1) among the target voltages that corresponds to the second performance state is performed after crawling the VMAT.

Example Clause P: The apparatus of any of Clauses I through O, wherein the performance number that is associated with the second performance state is less than the performance number that is associated with the first performance state, and wherein incrementally stepping the crawling performance number (Pn) comprises incrementally decrementing the crawling performance number (Pn).

Example Clause Q: The apparatus of any of Clauses I through P, wherein the first plurality of memories includes a first memory and a second memory, and wherein the memory assist values include at least a first memory assist value that is associated with the first memory and a second memory assist value that is associated with the second memory.

Example Clause R: A multi-core system-on-a-chip (SOC) (118), comprising: a first dynamic voltage and frequency scaling (DVFS) module (121A), comprising; a first Voltage and Memory Assist Table (VMAT) (141), comprising: a first plurality of firmware-programmable registers (133) that store target voltages that correspond to performance states; and a second plurality of firmware-programmable registers (134) that store first memory assist values (MA1₁, MA2₁) that correspond to the performance states, wherein the first memory assist values (MA1₁, MA2₁) are encoded with Gray encoding; a first domain (113) residing in a first core (111), the first domain (113) comprising a first plurality of memories (131, 132), wherein the first domain (113) operates on a clock frequency that is asynchronous with the first DVFS module (121A), and wherein the first DVFS module (121A) is configured to, during a current performance state of the first core: provide a first core voltage (Vcore1) to the first domain (113), such that the first core voltage (V_{core1}) is provided based on a target voltage (Vtarget1) among the target voltages that corresponds to the current performance state of the first core; and provide memory assist signaling to the first plurality of memories (131, 132), such that the memory assist signaling is provided based on the first memory assist values (MA1₁, MA2₁) that correspond to the current performance state of the first core; a second dynamic voltage and frequency scaling (DVFS) module (121B), comprising; a second Voltage and Memory Assist Table (VMAT) (142), comprising: a third plurality of firmware-programmable registers that store target voltages that correspond to performance states; and a fourth plurality of firmware-programmable registers that store second memory assist values (MA1₂, MA2₂) that correspond to the performance states, wherein the second memory assist values (MA1₂, MA2₂) are encoded with Gray encoding; and a second domain (114) residing in a second core (112), the second domain (114) comprising a second plurality of memories (136, 137), wherein the second domain (114) operates on another clock frequency that is asynchronous with the second DVFS module (121B), and wherein the second DVFS module (121B) is configured to, during a current performance state of the second core: provide a second core voltage (V_{core2}) to the second domain (114), such that the second core voltage (V_{core2}) is provided based on a target voltage (Vtarget2) among the target voltages that corresponds to the current performance state of the second core; and provide memory assist signaling to the second plurality of memories (136, 137), such that the memory assist signaling is provided based on the second memory assist values (MA1₂, MA2₂) that correspond to the current performance state of the second core.

Example Clause S: The multi-core SoC (118) of Clause R, wherein at least one of the first memory assist values (MA1₁, MA2₁) is associated with at least one of a voltage level that is associated with at least one memory of the first plurality of memories (131, 132) or a timing parameter that is associated with at least one memory of the plurality of memories (131, 132), and wherein at least one of the second memory assist values (MA1₂, MA2₂) is at least one of a voltage level that is associated with at least one memory of the second plurality of memories (136, 137) or a timing parameter that is associated with at least one memory of the plurality of memories (136, 137).

Example Clause T: The multi-core SoC (118) of any of Clauses R through S, further comprising a system control processor (SCP) 119, wherein the SCP (119) is arranged to execute firmware (109), wherein the firmware (109) is arranged to change the first memory assist values (MA1₁, MA2₁) stored in the second plurality of firmware-programmable registers (134), and wherein the firmware (109) is further arranged to change the second memory assist values (MA1₂, MA2₂) stored in the fourth plurality of firmware-programmable registers.

Features and technical benefits other than those explicitly described in the Summary above will be apparent from a reading of the Detailed Description and a review of the associated drawings. The Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instruction(s), module(s), algorithm(s), hardware logic, and/or operation(s) as permitted by the context described above and throughout the document.

In the above detailed description, reference is made to the accompanied drawings, which form a part hereof, and which is shown by way of illustration, specific example configurations of which the concepts can be practiced. These configurations are described in sufficient detail to enable those skilled in the art to practice the techniques disclosed herein, and it is to be understood that other configurations can be utilized, and other changes may be made, without departing from the spirit or scope of the presented concepts. The above detailed description is, therefore, not to be taken in a limiting sense, and the scope of the presented concepts is defined only by the appended claims.

The above description provides specific details for a thorough understanding of, and enabling description for, various examples of the technology. One skilled in the art will understand that the technology may be practiced without many of these details. In some instances, well-known structures and functions have not been shown or described in detail to avoid unnecessarily obscuring the description of examples of the technology. It is intended that the terminology used in this disclosure be interpreted in its broadest reasonable manner, even though it is being used in conjunction with a detailed description of certain examples of the technology. Although certain terms may be emphasized below, any terminology intended to be interpreted in any restricted manner will be overtly and specifically defined as such in this Detailed Description section. Throughout the specification and claims, the following terms take at least the meanings explicitly associated herein, unless the context dictates otherwise. The meanings identified below do not necessarily limit the terms, but merely provide illustrative examples for the terms. For example, each of the terms “based on” and “based upon” is not exclusive, and is equivalent to the term “based, at least in part, on,” and includes the option of being based on additional factors, some of which may not be described herein. As another example, the term “via” is not exclusive, and is equivalent to the term “via, at least in part,” and includes the option of being via additional factors, some of which may not be described herein. The phrase “in one example,” as used herein does not necessarily refer to the same embodiment or example, although it may. Use of particular textual numeric designators does not imply the existence of lesser-valued numerical designators. References in the singular are made merely for clarity of reading and include plural references unless plural references are specifically excluded. The term “or” is an inclusive “or” operator unless specifically indicated otherwise. For example, the phrase “A or B” means “A, B, or A and B.” As used herein, the terms “component” and “system” are intended to encompass hardware, software, or various combinations of hardware and software. Thus, for example, a system or component may be a process, a process executing on a computing device, the computing device, or a portion thereof. The meaning of “a,” “an,” and “the” includes plural reference, and the meaning of “in” includes “in” and “on.” The term “connected” means a direct electrical connection between the items connected, without any intermediate devices. The term “coupled” means a direct electrical connection between the items connected, or an indirect connection through one or more passive or active intermediary devices and/or components. The term “signal” means at least a power, current, voltage, data, electric wave, magnetic wave, electromagnetic wave, or optical signal. Based upon context, the term “coupled” may refer to a wave or field coupling effect, which may relate to a corresponding optical field, magnetic field, electrical field, or a combined electromagnetic field.

It will be understood that the configurations and/or approaches described herein are examples, and that these specific embodiments or examples are not to be considered in a limiting sense, because numerous variations are possible. As such, various systems, circuits, and/or devices may be broken into additional functions or circuits, and/or combined with other functions or circuits as may be desirable in a specific implementation. Similarly, the specific routines, procedures or methods described herein may represent one or more of any number of processing strategies. As such, various acts illustrated and/or described may be performed in the sequence illustrated and/or described, in other sequences, in parallel, or omitted. Likewise, the order of the above-described processes or methods may be changed. The subject matter thus includes all novel and non-obvious combinations and sub-combinations of the methods, processes, circuits, devices, systems and configurations, and other features, functions and/or properties disclosed herein, as well as any and all equivalents thereof.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A method for transitioning a system from a first performance state to a second performance state, the method comprising:
storing, in a first plurality of firmware-programmable registers in a first Voltage and Memory Assist Table (VMAT), target voltages that correspond to performance states, wherein the performance states include the first performance state and the second performance state;
storing, in a second plurality of firmware-programmable registers in the first VMAT, memory assist values (MA) that correspond to the performance states, wherein the memory assist values (MA) are encoded with Gray coding;
during a performance state change from the first performance state to the second performance state:
accessing the first plurality of firmware-programmable registers to determine a target voltage among the targets voltages that corresponds to the second performance state, and
accessing the second plurality of firmware-programmable registers to determine memory assist values among the memory assist values (MA) that correspond to the second performance state;
providing a first core voltage to a first plurality of memories on a first core, such that the first core voltage is provided based on the determined target voltage among the target voltages that corresponds to the second performance state; and
providing memory assist signaling to the first plurality of memories, such that the memory assist signaling is provided based on the determined memory assist values, wherein the first plurality of memories operate on a clock frequency that is asynchronous with the second plurality of firmware-programmable registers, wherein a clock boundary exists between the first plurality of memories and the second plurality of firmware-programmable registers, and wherein the Gray coding of the memory assist values creates single-bit transitions across the clock boundary.

2. The method of claim 1, further comprising:
via firmware, changing the memory assist values (MA) stored in the second plurality of firmware-programmable registers from a first set of memory assist values to a second set of memory assist values; and
after changing the memory assist values (MA):
accessing the second plurality of firmware-programmable registers to determine memory assist values among the second set of memory assist values, and
providing memory assist signaling to the first plurality of memories, such that the memory assist signaling is provided based on the memory assist values determined among the second set of memory assist values.

3. The method of claim 1, wherein at least one of the memory assist values (MA) is associated with at least one of a voltage level that is associated with at least one memory of the first plurality of memories or a timing parameter that is associated with at least one memory of the first plurality of memories.

4. The method of claim 1, further comprising, during the performance state change:
changing a clock signal from a first frequency associated with the first performance state to a second frequency associated with the second performance state, wherein the first performance state has a higher clock frequency than the second performance state;
referencing a target index, wherein performance numbers are associated with the performance states, and wherein the target index is associated with a target performance number among the performance numbers that indicates the second performance state;
creating a pointer index into the VMAT such that the pointer index points to a crawling performance number, such that the crawling performance number is adjustable, and such that, at a beginning of the performance state change, the crawling performance number is a performance number among the performance numbers that indicates the first performance state;
crawling the VMAT, wherein the crawling of the VMAT comprises:
incrementally stepping the crawling performance number,
at each incremental step of the crawling performance number, determining whether the memory assist values (MA) associated with the performance state among the performance states that is associated with the crawling performance number have changed,
at each incremental step of the crawling performance number at which it is determined that the memory assist values (MA) associated with the performance state among the performance states that is associated with the crawling performance number have changed:
using Gray encoding, providing memory assist signaling to the first plurality of memories, such that the memory assist signaling is provided based on the memory assist values (MA) that correspond to the performance state that is associated with the crawling performance number, and
at each incremental step of the crawling performance number at which it is determined that the memory assist values (MA) associated with the performance state among the performance states that is associated with the crawling performance number have not changed:
maintaining the memory assist signaling to the first plurality of memories,
at each incremental step of the crawling performance number, determining whether the memory assist values (MA) associated with the performance state among the performance states that is associated with the crawling performance number and the memory assist values (MA) associated with the second performance state are the same, and
upon determining that the memory assist values (MA) associated with the performance state among the performance states that is associated with the crawling performance number and the memory assist values (MA) associated with the second performance state are the same, stopping the crawling of the VMAT,
wherein providing the first core voltage to the first plurality of memories on the first core such that the first core voltage is provided based on the determined target voltage among the target voltages that corresponds to the second performance state is performed after crawling the VMAT.

5. The method of claim 4, wherein the performance number that is associated with the second performance state is greater than the performance number that is associated with the first performance state, and wherein incrementally stepping the crawling performance number comprises incrementally increasing the crawling performance number.

6. The method of claim 4, wherein the performance number that is associated with the second performance state is less than the performance number that is associated with the first performance state, and wherein incrementally stepping the crawling performance number comprises incrementally decrementing the crawling performance number.

7. The method of claim 4, wherein the first plurality of memories includes a first memory and a second memory, and wherein the memory assist values (MA) include at least a first memory assist value that is associated with the first memory and a second memory assist value that is associated with the second memory.

8. The method of claim 1, further comprising, during the performance state change:
raising a voltage level of the first core voltage provided to the first plurality of memories on the first core from a first level associated with a first performance state to a second level associated with the second performance state;
referencing a target index, wherein performance numbers are associated with the performance states, and wherein the target index is associated with a target performance number among the performance numbers that indicates the second performance state;
creating a pointer index into the VMAT such that the pointer index points to a crawling performance number, such that the crawling performance number is adjustable, and such that, at a beginning of the performance state change, the crawling performance number is a performance number among the performance numbers that indicates the first performance state;
crawling the VMAT, wherein the crawling of the VMAT comprises:
incrementally stepping the crawling performance number,
at each incremental step of the crawling performance number, determining whether the memory assist values (MA) associated with the performance state among the performance states that is associated with the crawling performance number have changed,
at each incremental step of the crawling performance number at which it is determined that the memory assist values (MA) associated with the performance state among the performance states that is associated with the crawling performance number have changed:
using Gray encoding, providing memory assist signaling to the first plurality of memories, such that the memory assist signaling is provided based on the memory assist values (MA) that correspond to the performance state that is associated with the crawling performance number, and
at each incremental step of the crawling performance number at which it is determined that the memory assist values (MA) associated with the performance state among the performance states that is associated with the crawling performance number have not changed:
maintaining the memory assist signaling to the first plurality of memories,
at each incremental step of the crawling performance number, determining whether the memory assist values (MA) associated with the performance state among the performance states that is associated with the crawling performance number and the memory assist values (MA) associated with the second performance state are the same, and
upon determining that the memory assist values (MA) associated with the performance state among the performance states that is associated with the crawling performance number and the memory assist values (MA) associated with the second performance state are the same, stopping the crawling of the VMAT, and
after crawling the VMAT,
changing a clock signal from a first frequency associated with the first performance state to a second frequency associated with the second performance state, wherein the first performance state has a lower clock frequency than the second performance state.

9. An apparatus, comprising:
a first dynamic voltage and frequency scaling (DVFS) module, comprising:
a first Voltage and Memory Assist Table (VMAT), comprising:
a first plurality of firmware-programmable registers that store target voltages that correspond to performance states, wherein the performance states include a first performance state and a second performance state, and
a second plurality of firmware-programmable registers that store memory assist values (MA) that correspond to the performance states, wherein the memory assist values (MA) are encoded with Gray encoding, and
a first domain residing in a first core, the first domain comprising a first plurality of memories, wherein the first domain operates on a clock frequency that is asynchronous with the first DVFS module, and wherein the first DVFS module is configured to:
during a performance state change from a first performance state to a second performance state:
access the first plurality of firmware-programmable registers to determine a target voltage among the targets voltages that corresponds to the second performance state, and
access the second plurality of firmware-programmable registers to determine memory assist values among the memory assist values (MA) that correspond to the second performance state,
provide a first core voltage to the first domain, such that the first core voltage is provided based on the determined target voltage, and
provide memory assist signaling to the first plurality of memories, such that the memory assist signaling is provided based on the determined memory assist values.

10. The apparatus of claim 9, wherein the first DVFS module is separate from the first core.

11. The apparatus of claim 9, wherein the first core includes the first DVFS module.

12. The apparatus of claim 9, wherein at least one of the memory assist values (MA) is associated with at least one of a voltage level that is associated with at least one memory of the first plurality of memories or a timing parameter that is associated with at least one memory of the plurality of memories.

13. The apparatus of claim 9, wherein the first DVFS module includes a first voltage regulator that is arranged to provide the first voltage based on the target voltage among the target voltages that corresponds to the current performance state.

14. The apparatus of claim 9, further comprising a system control processor, wherein the SCP is arranged to execute firmware, and wherein the firmware is arranged to change the memory assist values (MA) stored in the second plurality of firmware-programmable registers.

15. The apparatus of claim 9, wherein the first DVFS module is further configured to, during the performance state change:
provide a clock signal such that a frequency that is associated with the clock signal is associated with the second performance state;
reference a target index, wherein performance numbers are associated with the performance states, and wherein the target index is associated with a target performance number among the performance numbers that indicates the second performance state;
create a pointer index into the VMAT such that the pointer index points to a crawling performance number, such that the crawling performance number is adjustable, and such that, at a beginning of the performance state change, the crawling performance number is the performance number among the performance numbers that indicates the first performance state;
crawl the VMAT, wherein the crawling of the VMAT comprises:
incrementally step the crawling performance number,
at each incremental step of the crawling performance number, determine whether the memory assist values (MA) associated with the performance state among the performance states that is associated with the crawling performance number have changed,
at each incremental step of the crawling performance number at which it is determined that the memory assist values (MA) associated with the performance state among the performance states that is associated with the crawling performance number have changed:
using Gray encoding, provide memory assist signaling to the first plurality of memories, such that the memory assist signaling is provided based on the memory assist values (MA) that correspond to the performance state that is associated with the crawling performance number, and
at each incremental step of the crawling performance number at which it is determined that the memory assist values (MA) associated with the performance state among the performance states that is associated with the crawling performance number have not changed:
maintain the memory assist signaling to the first plurality of memories in the same manner as prior to the incremental step,
at each incremental step of the crawling performance number, determine whether the memory assist values (MA) associated with the performance state among the performance states that is associated with the crawling performance number and the memory assist values (MA) associated with the second performance state are the same, and
upon determining that the memory assist values (MA) associated with the performance state among the performance states that is associated with the crawling performance number and the memory assist values (MA) associated with the second performance state are the same, stopping the crawling of the VMAT,
wherein providing the first core voltage to the first plurality of memories on the first core such that the first core voltage is provided based on the determined target voltage among the target voltages that corresponds to the second performance state is performed after crawling the VMAT.

16. The apparatus of claim 15, wherein the performance number that is associated with the second performance state is less than the performance number that is associated with the first performance state, and wherein incrementally stepping the crawling performance number comprises incrementally decrementing the crawling performance number.

17. The apparatus of claim 15, wherein the first plurality of memories includes a first memory and a second memory, and wherein the memory assist values include at least a first memory assist value that is associated with the first memory and a second memory assist value that is associated with the second memory.

18. A multi-core system-on-a-chip (SOC), comprising:
a first dynamic voltage and frequency scaling (DVFS) module, comprising;
a first Voltage and Memory Assist Table (VMAT), comprising:
a first plurality of firmware-programmable registers that store target voltages that correspond to performance states, and
a second plurality of firmware-programmable registers that store first memory assist values that correspond to the performance states wherein the first memory assist values are encoded with Gray encoding,
a first domain residing in a first core, the first domain comprising a first plurality of memories, wherein the first domain operates on a clock frequency that is asynchronous with the first DVFS module, and wherein the first DVFS module is configured to, during a current performance state of the first core:
provide a first core voltage to the first domain, such that the first core voltage is provided based on a target voltage among the target voltages that corresponds to the current performance state of the first core, and
provide memory assist signaling to the first plurality of memories, such that the memory assist signaling is provided based on the first memory assist values that correspond to the current performance state of the first core;
a second DVFS module, comprising;
a second VMAT, comprising:
a third plurality of firmware-programmable registers that store target voltages that correspond to the performance states, and
a fourth plurality of firmware-programmable registers that store second memory assist values that correspond to the performance states wherein the second memory assist values are encoded with Gray encoding; and
a second domain residing in a second core, the second domain comprising a second plurality of memories, wherein the second domain operates on another clock frequency that is asynchronous with the second DVFS module, wherein the second DVFS module is configured to, during a current performance state of the second core:
provide a second core voltage to the second domain, such that the second core voltage is provided based on a target voltage among the target voltages that corresponds to the current performance state of the second core, and
provide memory assist signaling to the second plurality of memories, such that the memory assist signaling is provided based on the second memory assist values that correspond to the current performance state of the second core.

19. The multi-core SoC of claim 18, wherein at least one of the first memory assist values is associated with at least one of a voltage level that is associated with at least one memory of the first plurality of memories or a timing parameter that is associated with at least one memory of the plurality of memories, and wherein at least one of the second memory assist values is associated with at least one of a voltage level that is associated with at least one memory of the second plurality of memories or a timing parameter that is associated with at least one memory of the plurality of memories.

20. The multi-core SoC of claim 18, further comprising a system control processor (SCP), wherein the SCP is arranged to execute firmware, wherein the firmware is arranged to change the first memory assist values stored in the second plurality of firmware-programmable registers, and wherein the firmware is further arranged to change the second memory assist values stored in the fourth plurality of firmware-programmable registers.
